(19) United States
(12) Patent Application Publication
(10) Pub. No.: US 2026/0247101 A1
(43) Pub. Date: Aug. 20, 2026

(54) METHODS FOR MOBILITY-TRIGGERED LOCATION VERIFICATION

(71) Applicant: InterDigital Patent Holdings, Inc., Wilmington, DE (US)

(72) Inventors: Fumihiro HASEGAWA, Westmount (CA); Dylan WATTS, Montreal (CA); Keiichi KUBOTA, Setagaya-ku (JP); Jaya RAO, Montreal (CA); Paul MARINIER, Brossard (CA); Moon IL LEE, Melville, NY (US)

(73) Assignee: InterDigital Patent Holdings, Inc., Wilmington, DE (US)

(21) Appl. No.: 19/154,670

(22) PCT Filed: Feb. 14, 2024
(86) PCT No.: PCT/US2024/015729

§ 371 Date: Aug. 7, 2025

Related U.S. Application Data
(60) Provisional application No. 63/445,628, filed on Feb. 14, 2023.

(51) Int. Cl. H04W 4/02; G01S 5/00; G01S 5/02; G01S 19/25; H04W 76/10; H04W 84/06

(52) U.S. Cl. CPC H04W 4/023; G01S 5/0027; G01S 5/0244; G01S 19/258; H04W 76/10; H04W 84/06

(57) ABSTRACT

Methods for mobility-triggered location verification are provided herein. A method may include receiving assistance information comprising at least satellite ephemeris information, and detecting movement from a reference point, wherein the movement exceeds a distance threshold. The method may include determining a location verification occasion based on the received satellite ephemeris information. The method may include, on a condition the determined location verification occasion is within a time threshold, transmitting location verification information to a network at the determined location verification occasion. The assistance information may include an indication of the distance threshold. The assistance information may include an indication of the time threshold. The method may further include detecting a mobility event. The method may further include, on a condition the determined verification occasion occurs after a preconfigured time from the detected mobility event, performing initial access to establish a connection to the network.

### CROSS-REFERENCE TO RELATED APPLICATIONS

This application claims the benefit of U.S. Provisional Application No. 63/445,628, filed Feb. 14, 2023, the contents of which are incorporated herein by reference.

### BACKGROUND

Non-terrestrial networks (NTNs) may facilitate deployment of wireless networks in areas where land-based antennas are impractical, for example due to geography or cost. It is envisioned that, coupled with terrestrial networks, NTNs may enable truly ubiquitous coverage of 5G networks. Initial 3GPP Rel-17 NTN deployments support basic talk and text anywhere in the world; however, it is expected that further releases coupled with proliferation of next-generation low-orbit satellites will enable enhanced services such as web browsing.

A basic NTN may include an aerial or space-borne platform which, via a gateway (GW), transports signals from a land-based based base station to a WTRU and vice-versa. Current Rel-17 NR NTNs may support, for example, power class 3 WTRUs with omnidirectional antenna(s) and linear polarization, or very small aperture antenna (VSAT) terminals with directive antenna(s) and circular polarization. Support for LTE-based narrow-band IoT (NB-IoT) and eMTC type devices are also standardized in Rel-17. Regardless of device type, it is assumed all Rel-17 NTN WTRUs are global navigation satellite system (GNSS) capable.

### SUMMARY

Methods for mobility-triggered location verification are provided herein. A method may include receiving assistance information comprising at least satellite ephemeris information, and detecting movement from a reference point, wherein the movement exceeds a distance threshold. The method may include determining a location verification occasion based on the received satellite ephemeris information. The method may include, on a condition the determine verification occasion is within a time threshold, transmitting location verification information to a network at the determined location verification occasion. The assistance information may include an indication of the distance threshold. The assistance information may include an indication of the time threshold. The method may further include detecting a mobility event. The method may further include, on a condition the determined verification occasion occurs after a preconfigured time from the detected mobility event, performing initial access to establish a connection to the network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration depicting different actors and interfaces in a non-terrestrial network;

FIG. 3 is a diagram illustrating an example of discontinuous coverage;

FIG. 4 is a diagram illustrating an example of the preparation time of a WTRU in relation to an actual verification occasion;

FIG. 5 is a diagram illustrating an example procedure for RTT-based positioning;

FIG. 6 is a diagram illustrating a relationship between satellite positions, PRS reception and SRS transmission from the WTRU;

FIG. 7 is a diagram illustrating the configuration of a WTRU with periodic verification occasions from the network;

FIG. 8 is a diagram illustrating periods of visibility of satellites;

FIG. 9 is a diagram illustrating the determination of a new verification occasion;

FIG. 10 is a diagram illustrating a rejection of a new verification occasion;

FIG. 11 is a diagram illustrating a location verification determination performed by a WTRU;

FIG. 12 is a diagram illustrating an example in which the WTRU determines a periodicity for location verification;

FIG. 13 is a diagram illustrating an example of relationship between a required minimum periodicity for verification and range with respect to the NTN cell center;

FIG. 14 is a diagram illustrating examples of sets of verification occasions;

FIG. 15 is a flow diagram illustrating an example procedure for mobility-triggered location verification;

FIG. 16 is a flow diagram illustrating an example procedure for network initiated verification with a penalty for skipped occasions; and

FIG. 17 is a flow diagram illustrating an example procedure for WTRU-initiated location verification.

### DETAILED DESCRIPTION

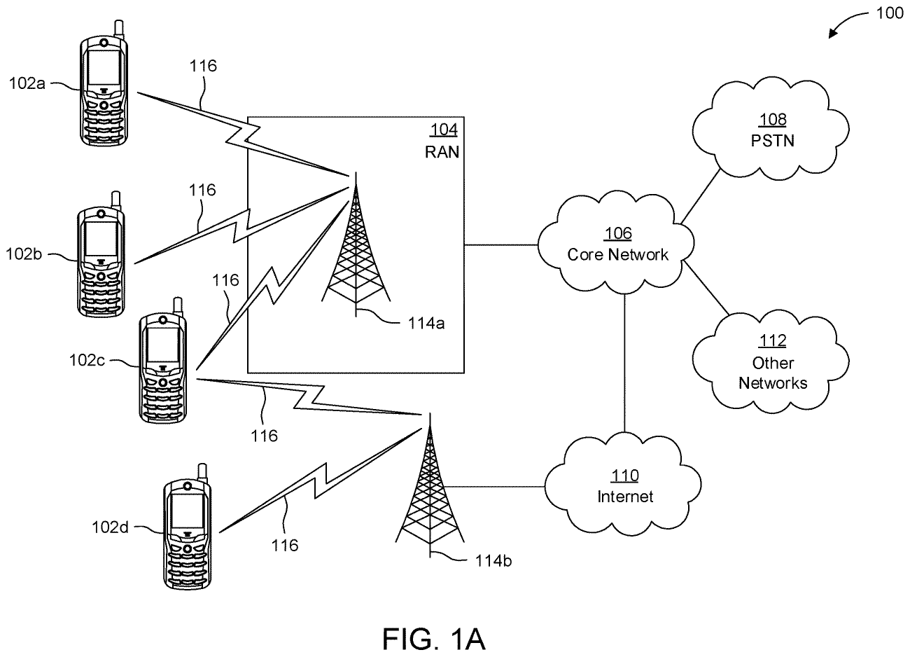

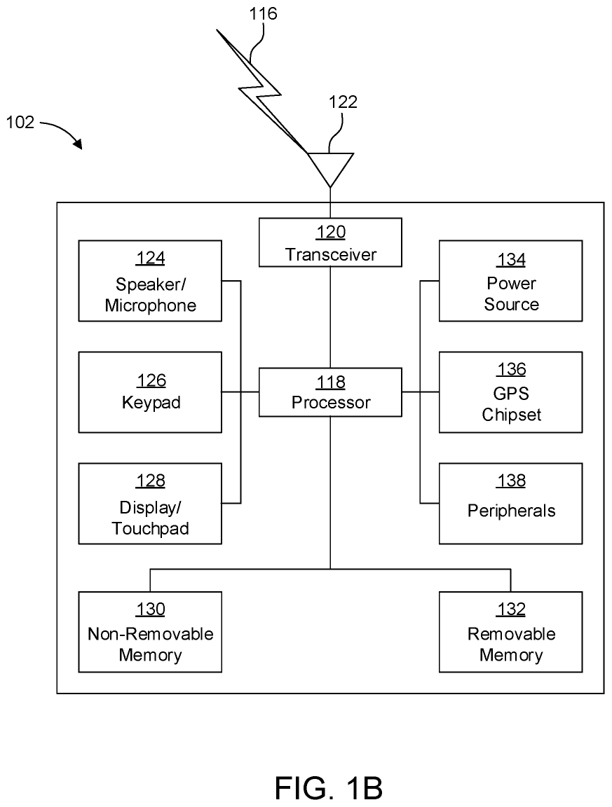

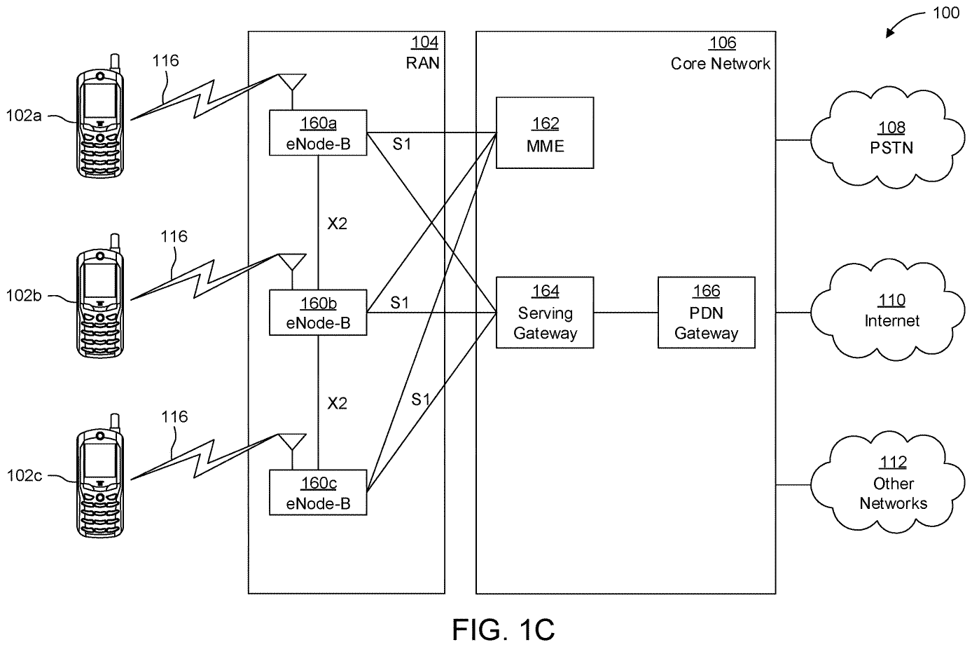

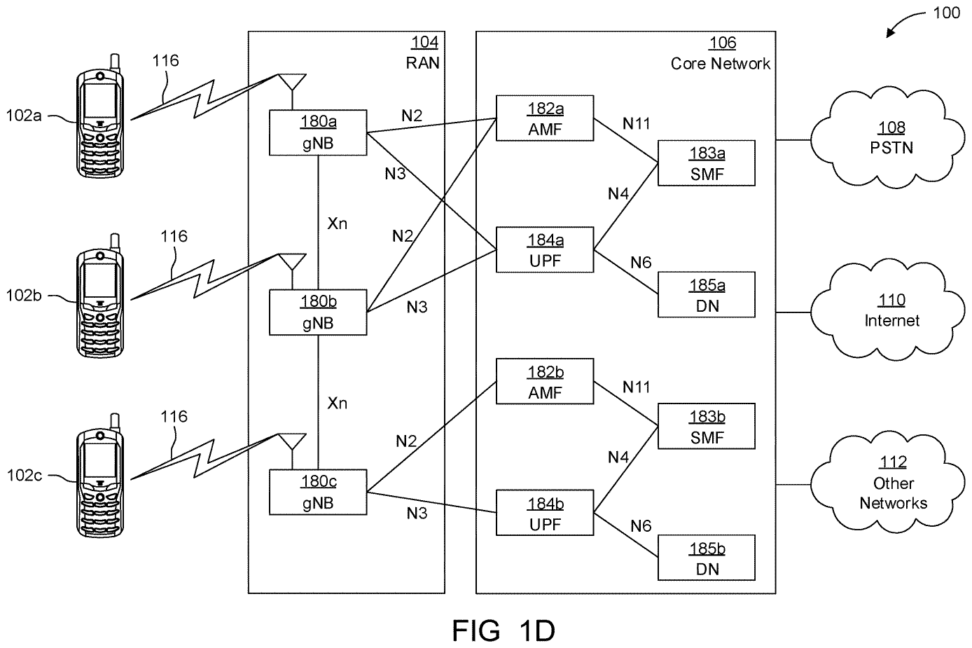

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, nodeB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A list of abbreviations and acronyms as used in the following paragraphs is provided as follows:
ACK Acknowledgement
AoA Angle of Arrival
AoD Angle of Departure
ARFCN Absolute Radio-Frequency Channel Number
BLER Block Error Rate
BW Bandwidth
BWP Bandwidth Part
CAP Channel Access Priority
CAPC Channel access priority class
CCA Clear Channel Assessment
CCE Control Channel Element
CE Control Element
CG Configured Grant or Cell Group
CORESET Control Resource Set
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
DRX Discontinuous Reception
ECID Enhanced Cell ID
eLAA enhanced Licensed Assisted Access
eMBB enhanced Mobile Broadband
FeLAA Further enhanced Licensed Assisted Access
GNSS Global Navigation Satellite System
GPS Global Positioning System
HARQ Hybrid Automatic Repeat Request
IM Interference Measurement
LAA License Assisted Access
LBT Listen Before Talk
LCH Logical Channel
LCP Logical Channel Priority
LBT Listen-Before-Talk
LOS Line of Sight
NLOS Non Line of Sight
LMF Location Management Function
LPP LTE Positioning Protocol
LTE Long Term Evolution (e.g. from 3GPP LTE R8 and up)
MAC CE MAC Control Element
MAC Medium Access Control
MCS Modulation and Coding Scheme
MIMO Multiple Input Multiple Output
NACK Negative ACK
NAS Non-access stratum
NGSO Non-geostationary satellite systems
NR New Radio
NTN Non-terrestrial networks
OFDM Orthogonal Frequency-Division Multiplexing
OTDOA Observed Time Difference of Arrival
PDCCH Physical Downlink Control Channel
PDSCH Physical Downlink Shared Channel
PDU Packet Data Unit
PHY Physical Layer
PID Process ID
PO Paging Occasion
PRACH Physical Random Access Channel
PRS Positioning Reference Signal
PRU Positioning Reference Unit
PSS Primary Synchronization Signal
PTRS Phase Tracking Reference Signal
PUCCH Physical Uplink Control Channel
PUSCH Physical Uplink Shared Channel
RA Random Access (or procedure)
RACH Random Access Channel
RAR Random Access Response
RCU Radio access network Central Unit
RE Resource Element
RF Radio Front end
RLF Radio Link Failure
RLM Radio Link Monitoring
RNTI Radio Network Identifier
RNA RAN Notification Area
RO RACH occasion
RRC Radio Resource Control
RRM Radio Resource Management
RTT Round Trip Time
RP Reception Point
RS Reference Signal
RSRP Reference Signal Received Power
RSTD Reference Signal Time Difference
RTT Round Trip Time
RSSI Received Signal Strength Indicator
RTOA Relative Time of Arrival
SDAP Service data adaptation protocol
SDU Service Data Unit
SRB Signaling Radio Bearer
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TDoA Time Difference of Arrival
TRP Transmission-Reception Point
TP Transmission Point
TSC Time-sensitive communications
TSN Time-sensitive networking
TTI Transmission Time Interval
UCI Uplink Control Information
UL Uplink
URLLC Ultra-Reliable and Low Latency Communications
WBWP Wide Bandwidth Part
WLAN Wireless Local Area Networks and related technologies (IEEE 802.xx domain)

Rel-17 NTN deployment scenarios are described herein. Aerial or space-borne platforms may be classified in terms of orbit, with Rel-17 standardization focusing on low-earth orbit (LEO) satellites having an altitude range of 300-1500 km and geostationary earth orbit (GEO) satellites with altitude at 35,786 km. Other platform classifications such as medium-earth orbit (MEO) satellites with altitude range 7000-25000 km and high-altitude platform stations (HAPS) with altitude of 8-50 km may be supported. Satellite platforms may be further classified as having a “transparent” or “regenerative” payload. Transparent satellite payloads may implement frequency conversion and RF amplification in both uplink and downlink, with multiple transparent satellites possibly connected to one (or more) land-based base station. Regenerative satellite payloads can implement a full base station or base station DU onboard the satellite. Regenerative payloads may perform digital processing on the signal including demodulation, decoding, re-encoding, re-modulation and/or filtering.

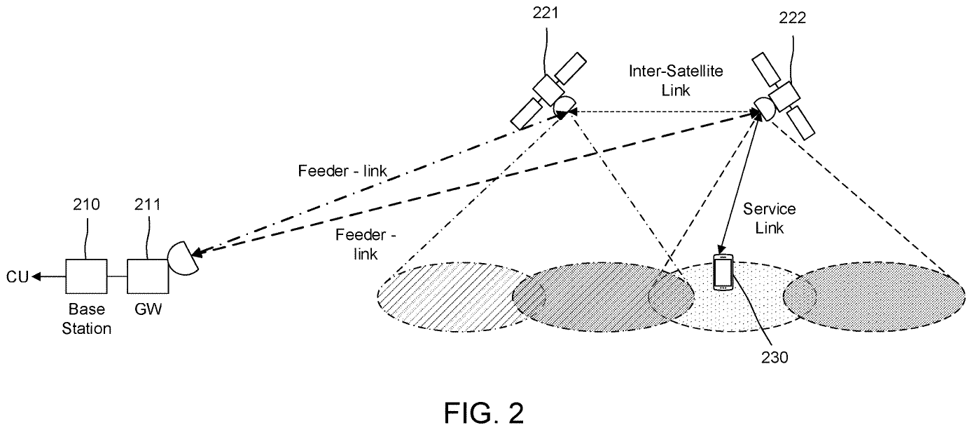

FIG. 2 depicts interfaces in a non-terrestrial network (NTN). The NTN may include, for example, a ground segment made up of one or more base stations 210, each base station 210 having or communicating with a gateway (GW) 211 that communicates with satellites 221 and 222 that are part of the NTN constellation. The GW 211 may establish and maintain connections with satellites 221 and 222, enabling data transmission between the terrestrial network and space-based assets. Satellites 221 and 222, provides service to one or more WTRUs 230 within their coverage areas. The NTN may include one or more WTRUs 230 which may be such as smartphones, tablets, IoT devices, and/or specialized equipment, that are configured connect to both terrestrial 5G infrastructure and satellites in the NTN. If configured to connect to both terrestrial 5G infrastructure and the NTN devices may have capability to switch between terrestrial and satellite connections seamlessly, depending on the coverage area.

As shown in FIG. 2, the following radio interfaces may be defined in the NTN: one or more feeder-links (e.g., wireless links between the GW 211 and satellites 221 and 222; one or more service links (e.g., a radio link between satellite 222 and WTRU 230); and an one or more inter-satellite Links (ISLs). The ISLs may include, for example, a transport link between satellites 221 and 222, which may be supported only by regenerative payloads and may be a 3GPP radio or proprietary optical interface.

A regenerative payload may refer to a payload designed to assist in the reception, processing, and retransmission of signals for improved quality and efficiency of the ISL and/or service link. A regenerative payload may be transmitted using a variety of techniques such as amplification, error correction, frequency correction, beamforming, among others, allowing the NTN to extend coverage, enhance signal quality, and provide reliable communication.

Depending on the satellite payload configuration, different 3GPP interfaces may be used for each radio link. In the case of transparent payloads, the NR-Uu radio interface may be used for both the service link and feeder-link. For regenerative payloads, the NR-Uu interface may be used on the service link, and a satellite radio interface (SRI) may be used for the feeder-link. 3GPP has not currently defined ISLs for Rel-17. A detailed UP/CP protocol stack for a transparent payload configuration as may be used consistently with 3GPP TR 38.821 is described in later paragraphs herein.

An NTN satellite may support multiple cells, and each cell may provide coverage via one or more satellite beams. Satellite beams may cover a footprint on earth (e.g., akin to a terrestrial cell) and may range in diameter from 100 to 1000 km in LEO deployments, and from 200 to 3500 km in GEO deployments. Beam footprints, in GEO deployments for example, may remain fixed relative to earth, and, in LEO deployments for example, the area covered by a beam/cell may change over time due to satellite movement. This beam movement may be classified as “earth moving” where the beam moves continuously across the earth, or “earth fixed” where the beam is steered to maintain coverage over a fixed location until a new cell overtakes the coverage area in a discrete and coordinated change.

Due to the altitude of NTN platforms and beam diameters, the round-trip time (RTT) and maximum differential delay may be significantly larger than that of terrestrial systems. In a typical transparent NTN deployment, the RTT may range from 25.77 ms (LEO @ 600 km altitude) to 541.46 ms (GEO) and maximum differential delay may range from 3.12 ms to 10.3 ms. The RTT of a regenerative payload may be approximately half that of a transparent payload, as a transparent configuration includes both the service and feeder links, whereas the RTT of a regenerative payload may consider the service link only. To minimize impacts to existing NR systems (e.g. to avoid preamble ambiguity or to properly time reception windows), WTRU may perform timing pre-compensation prior to initial access.

User Plane enhancements are described herein.

Time/Frequency precompensation is one type of User Plane enhancement that may be performed in Rel-17 NTNs. A pre-compensation procedure may prompt or require the WTRU to obtain its position via GNSS, and obtain the feeder-link (or common) delay and satellite position via satellite ephemeris data. The satellite ephemeris data may be periodically broadcasted in system information, and may contain information such as satellite speed, direction, and velocity. The WTRU may then estimate the distance (and thus delay) from the satellite, and then add the feeder-link delay component to obtain the full WTRU-base station RTT, which may then be used to offset timers, reception windows, or timing relations (e.g., timing relations related to random access, including the ra-ResponseWindow, msgb-ReponseWindow, and the ra-ContentionResolutionTimer). It may be assumed that frequency compensation is performed by the network and/or WTRU. Examples of frequency compensation described herein may include correction, application, and/or removal of a frequency offset in the carrier frequency.

Since the WTRU-specific TA (and thus the WTRU-base station RTT) may be calculated by the WTRU, a new procedure may be defined in Rel-17 to report the TA estimate to network via a new MAC CE, or other logically equivalent signaling. A Timing Advance report (TAR) may be triggered based on one or more of the following conditions: upon indication from upper layers to trigger a Timing Advance report; upon configuration of offsetThresholdTA by upper layers, if the WTRU has not previously reported Timing Advance value to current Serving Cell; if the variation between current information about Timing Advance and the last reported information about Timing Advance is equal to or larger than offsetThresholdTA, if configured.

HARQ and DRX enhancements are described herein. A WTRU may be semi-statically configured (e.g., via RRC signaling) to apply a specific HARQ behavior to a set of HARQ process IDs (or in other words, to associate certain HARQ behavior or procedures with one or more HARQ process IDs). This configuration may be carried out per serving cell, and may be optionally configured for both UL and DL HARQ processes via one or more the optional configurations. One optional configuration or parameter, referred to herein as downlinkHARQ-feedbackDisabled, may be configured per HARQ process ID, and may indicate whether DL HARQ feedback is enabled or disabled. Another optional configuration or parameter, referred to herein as uplinkHARQ-Mode, may be configured per HARQ process ID, and may indicate whether an UL HARQ process uses HARQModeA or HARQmodeB. HARQmodeA may best apply to transmissions with UL HARQ retransmission enabled, and HARQmodeB may best apply to transmissions with UL HARQ retransmission disabled or with blind UL retransmission.

A WTRU may adapt DRX timers based on the configured HARQ characteristics of a HARQ process. DRX may be adapted for both UL and DL to either adapt DRX active time account for additional propagation delay (e.g. if HARQ feedback is enabled) or to enabled additional WTRU power saving (e.g. if HARQ feedback is disabled). Operation may be adapted as follows.

For DL operation, if the parameter downlinkHARQ-FeedbackDisabled is configured for this serving cell, upon DL reception one or more of the following conditions may apply. If HARQ feedback is enabled for a HARQ process, the WTRU may extend the length of the DL HARQ RTT Timer by, or based on, the WTRU-base station RTT (i.e propagation delay). If HARQ feedback is disabled for the HARQ process, the WTRU may not start drx-RetransmissionTimerDL to enable additional power saving. If the parameter downlinkHARQ-FeedbackDisabled is not configured, the WTRU may apply legacy behavior (i.e. start drx-RetransmissionTimerDL after expiry of a time window defined by drx-HARQ-RTT-TimerDL).

For UL operation, if uplinkHARQ-Mode is configured for this serving cell, upon UL transmission one or more of the following conditions may apply. If a HARQ process is configured as HARQModeA the WTRU may extend the length of the DL HARQ RTT Timer by the WTRU-base station RTT (i.e. extend the DL HARQ RTT Timer by the propagation delay). If a HARQ process is configured as HARQModeB, the WTRU may not start drx-RetransmissionTimerDL to enable additional power saving. If uplinkHARQ-Mode is not configured, the WTRU will apply legacy behavior (i.e. start drx-RetransmissionTimerUL after expiry of drx-HARQ-RTT-TimerUL).

LCP enhancements based on HARQ behavior are described herein. A WTRU may be configured to apply an LCP restriction based on the UL HARQ mode configured for the HARQ process ID an UL grant is assigned to. WTRU behavior may be specified via two or more optional RRC configurations. An example may be the parameter uplinkHARQ-Mode, which may configure each HARQ process ID as either HARQModeA or HARQModeB. Another example may be the parameter allowedHARQ-Mode, which may be configured per logical channel and may set the allowed HARQ mode of a HARQ process mapped to this logical channel.

Upon reception of a new UL grant, the WTRU may determine whether the parameter allowedHARQ-mode is configured for this LCH, and whether a HARQ Mode has been configured for the HARQ process the UL grant is assigned to. If both are configured and the LCH is allowed to be mapped to the HARQ mode, the restriction may be satisfied and data from this logical channel may be mapped to the UL grant. If either uplinkHARQ-Mode or allowedHARQ-Mode are not configured, the WTRU may map this logical channel to any HARQ process.

A description of Control Plane enhancements is provided herein. RRC_CONNECTED enhancements as may be utilized in Rel-17 NTNs are described in detail as follows. Rel-17 enhancements relevant to RRC_CONNECTED mode may focus on adapting mobility and measurement procedures to non-terrestrial environments. Key modifications to mobility and measurement procedures may include additional execution conditions for conditional handover such as the A4 event, and time/location-based conditions. Such modifications are described further in paragraphs below. In IDLE mode, the WTRU may not have any connection to the network, and mobility (i.e., cell (re)selection) is performed by the WTRU. The WTRU may need to establish the connection with the network so that the WTRU can transition to RRC_CONNECTED mode. During RRC_CONNECTED mode, the WTRU can transmit and/or receive data to or from the network, and procedures such as measurement reporting and mobility between cells are controlled by the network. During INACTIVE mode, the WTRU may remain connected to the core network (i.e., WTRU context is known and stored at the core network), however the WTRU may not be connected to the RAN network. The WTRU may retain contexts (e.g., configurations) that the WTRU obtained during RRC_CONNECTED mode. DURING INACTIVE mode, the WTRU may be in a sleep mode during which the WTRU may not monitor for channels or signals transmitted from the network. During INACTIVE mode, the WTRU may wake up, based on a configured trigger event, to receive or monitor for channels or signals transmitted by the network. The WTRU may wake up, based on a configured trigger event, to transmit signals or channels to the network during the INACTIVE mode.

Some examples of location-based events may be defined, for example by condEventD1, where an event may be satisfied if a distance between the WTRU and a first reference location (e.g. a location associated with or a location within the serving cell) is above a threshold and a second reference location (e.g. a location associated with or a location within a neighboring cell) is below a threshold. A time-based event may be defined, for example by condEventT1, where the event may be satisfied if conditional handover execution occurs between T1 and T2, where T2=T1+a duration. Both time and location-based trigger conditions may need to be simultaneously configured with a measurement condition (e.g. A4) for Rel-17 NTNs.

Some methods, enhancements, or modifications to existing procedures may apply to measurements, and may include one or more aspects as follows. Some modifications may include location-based measurement reporting (based on eventD1, with similar execution conditions as condEventD1). In some methods, Multiple SSB/PBCH block measurement timing configurations (SMTCs) may be configured (e.g., per carrier) for a given set of cells using parameters such as propagation delay difference, feeder-link delay, and serving/neighbor cell satellite ephemeris information. In some methods, measurement gaps may be configured using the same propagation delay differences as computed for a SMTC. Enhanced mobility may of special interest in LEO deployments where, due to satellite movement, even a stationary WTRU may be expected to perform mobility procedures, for example, approximately every seven seconds (e.g., depending on deployment characteristics).

Methods for use in RRC_IDLE/INACTIVE states are proposed herein. Methods proposed in the following paragraphs may include or involve enhancements to existing procedures defined for Rel-17 NTNs. Rel-17 enhancements to IDLE/INACTIVE cell reselection may focus, for example, on new measurement rules. Some enhancements may be specified based on a WTRU's distance from a cell reference point, and/or based on the time a quasi-Earth cell will stop serving the current area (which may be indicated and referred to throughout paragraphs herein by the parameter t-Service). A cell reference point, the parameter t-Service, and distance Thresh (representing, for example, a parameter used to evaluate the distance condition) may be broadcast in system information such as SIB19, a new system information block that may carry NTN-specific information.

A location-based enhancement may enable measurement relaxation (e.g., a change in timing/frequency of measurements) when a WTRU is located within a threshold distance (e.g., represented by the parameter distance Thresh) from a cell reference point (e.g., the cell center of a cell). In some cases, a WTRU may not perform intra-frequency measurements, measurements of NR inter-frequency cells of equal or lower priority, or inter-RAT frequency cells of lower priority if any one or all of following conditions are satisfied: the serving cell fulfils Srxlev>S_{IntraSearchP} and Squal>S_{IntraSearchQ}; the WTRU has valid WTRU location information; and/or the distance between the WTRU and the serving cell reference location is shorter than distanceThresh. For example, Srxlev and S_{IntraSearchP} may indicate a cell reselection Rx value and threshold based on intra-frequency measurements, respectively. Squal and S_{IntraSearchQ} are cell reselection quality value and threshold based on intra-frequency measurements, respectively.

A time-based enhancement may require a WTRU to perform cell re-selection measurements in a quasi-earth fixed cell at some time prior to t-Service (although the exact timing may be up to WTRU implementation). The WTRU may perform intra-frequency, inter-frequency, or inter-RAT measurements before t-Service regardless of the distance between the WTRU and serving cell measurement or whether the serving cell fulfils Srxlev>S_{IntraSearchP} and Squal>S_{IntraSearchQ}, or Srxlev>S_{nonIntraSearchP} and Squal>S_{nonIntraSearchQ}.

These distance and time-based measurement rules may be implemented without affecting procedures for measurements of higher-priority NR inter-frequency or inter-RAT frequencies. The WTRU may perform measurements of higher-priority NR inter-frequency or inter-RAT frequencies regardless of remaining service time or distance from the cell reference point.

NTNs for IoT applications are described herein. Many Rel-17 enhancements specified for NR NTNs may also be adopted for IoT NTN, including: time/frequency precompensation; timing advance reporting; timer and monitoring window offset; and/or cell (re)selection enhancements based on t-service. Other enhancements such as disabled HARQ feedback and mobility enhancements are under discussion in Rel-18. One enhancement unique to IoT NTN may be the consideration of discontinuous coverage scenario.

Discontinuous coverage scenarios are described herein. Discontinuous coverage in NT Ns may refer to temporary and predictable coverage gaps that may be caused by non-continuous coverage in NGSO deployments. Although not an issue if continuous coverage is available globally, this may not be the case in early NTN deployments or in deeply rural areas. Enhancements may be specified for IoT NTNs to address the discontinuous coverage scenario, but have not yet been addressed in NR.

Due to deterministic satellite movement, coverage gaps may be predicted and accounted for, and Rel-17 IoT NTNs may support additional assistance information (e.g. satellite ephemeris and coverage parameters such as footprint radius, cell reference points or elevation angles, and the start time of service for a neighboring cell (which may be given by and referred to herein as t-servicestart) to predict the duration of a coverage gap. While within a discontinuous coverage gap, the WTRU may suspend Access Stratum functionality.

Positioning methods are described herein. In deployments operating in accordance with Rel. 16 specifications, downlink, uplink and downlink and uplink positioning methods (e.g., RAT dependent positioning methods) may be used. In the following paragraphs, various positioning methods are considered. A “DL positioning method” as referred to herein may refer to any positioning method that uses downlink reference signals such as PRS. The WTRU may receive multiple reference signals from TP(s) and measures DL RSTD and/or RSRP. Examples of DL positioning methods include DL-AoD or DL-TDOA positioning. An “UL positioning method” as referred to herein may refer to any positioning method that uses uplink reference signals such as SRS for positioning. The WTRU may transmit SRS to multiple RPs and the RPs measure the UL RTOA and/or RSRP. Examples of UL positioning methods are UL-TDOA or UL-AoA positioning.

A “DL & UL positioning method” as referred to herein may refer to any positioning method that uses both uplink and downlink reference signals for positioning. In some examples, a WTRU may transmit SRS to multiple TRPs and a base station may measure the Rx-Tx time difference which is calculated based on the time of arrival of DL RS (e.g., PRS). The base station may measure an RSRP for the received SRS. The WTRU may measure an Rx-Tx time difference for PRSs transmitted by multiple TRPs. The WTRU may measure the RSRP for a received PRS. The Rx-TX difference and possibly the RSRP measured at the WTRU and base station may be used to compute a round trip time. Here, the term “WTRU Rx-Tx time difference” may refer to a difference between an arrival time of the reference signal transmitted by the TRP and a transmission time of the reference signal transmitted from the WTRU. An example of DL & UL positioning method may be, for example, multi-RTT positioning.

Various terminology as may be used herein is described as follows. As used herein, the term “network” may include reference to an AMF, LMF, base station or NG-RAN. The terms “pre-configuration” and “configuration” may be used interchangeably herein. “Non-serving base station” and “neighboring base station” may be used interchangeably herein. The terms “base station,” “nodeB,” and “TRP” may be used interchangeably herein. The terms “PRS”, “SRS”, “SRS for positioning” or “SRS for positioning purpose” may be used interchangeably herein. The terms “PRS” or “PRS resource” may be used interchangeably herein. The terms “PRS(s)” or “PRS resource(s)” may be used interchangeably herein. The aforementioned “PRS(s)” or “PRS resource(s)” may belong to different PRS resource sets. “PRS” or “DL-PRS” or “DL PRS” may be used interchangeably herein. The terms “measurement gap” or “measurement gap pattern” may be used interchangeably herein. The term “measurement gap pattern” may include parameters such as measurement gap duration or measurement gap repetition period or measurement gap periodicity.

A PRU may be a WTRU or TRP whose location (e.g., altitude, latitude, geographic coordinate, or local coordinate, or proximity to another known location) is known by the network (e.g., by the base station, and/or the LMF, or another network entity or device). The capabilities of a PRU may be same as a WTRU or TRP. For example, a PRU may be capable of receiving PRS or SRS or transmitting SRS for positioning, return measurements, or transmit PRS. The WTRUs acting as PRUs may be used by the network for calibration purposes (e.g., correct unknown timing offset, correct unknown angle offset).

The LMF may be one non-limiting example of a node or entity (e.g., network node or entity) that may be used for or to support positioning. It should be appreciated that any other node or entity may be substituted for LMF and still be consistent with this disclosure. The WTRU may receive information indicating configured or preconfigured threshold(s) from the network (e.g., LMF, base station).

A line of sight (LOS) indicator may be a hard indicator (e.g., 1 or 0) or a soft indicator (e.g., 0, 0.1, 0.2 . . . , 1) and may indicate the likelihood of the presence of an LOS path between TRP and WTRU or along PRS. The LOS indicator may be associated with a TRP or PRS resource ID (e.g., index). The WTRU may receive a LOS indicator from the network per (i.e., associated with) a TRP or resource ID. Alternatively, or additionally, the WTRU may determine or derive a LOS indicator per TRP or resource ID based on measurements.

Various problems addressed by embodiments described herein are described in the following paragraphs. In NTNs, the WTRU location may be verified by the network (e.g., LMF, base station) by comparing a reported GNSS/GPS location and the result (e.g., measurements reported by the WTRU) of one or more NTN-based RAT dependent positioning methods. The WTRU may experience periods of the aforementioned discontinuous coverage or coverage gap (e.g., no satellite coverage) due to ephemeris of NTN satellites.

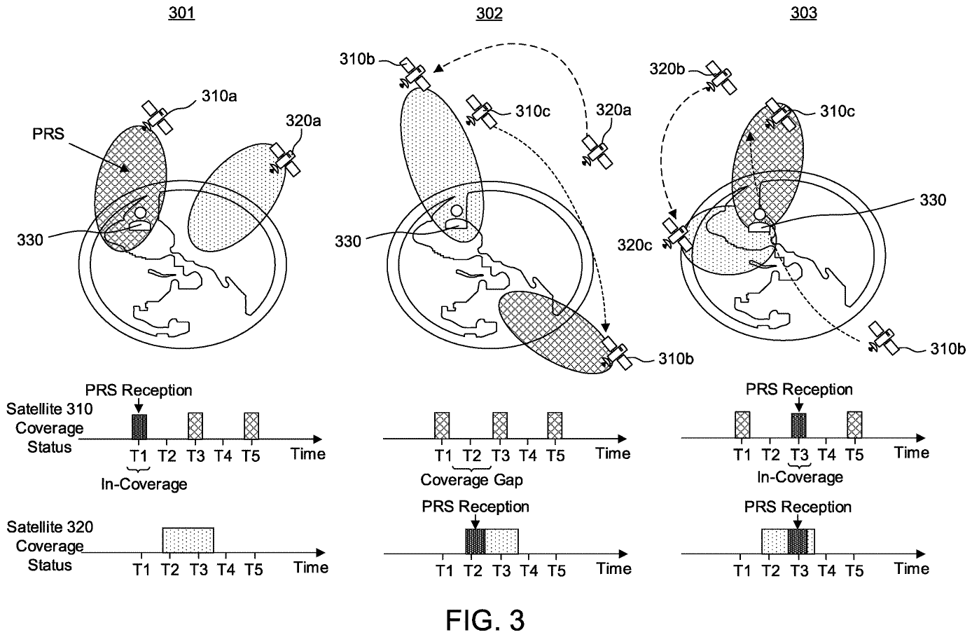

FIG. 3 is a diagram illustrating an example of discontinuous coverage. An example of an NTN as shown in FIG. 3 may include at least two satellites 310 and 320 and a WTRU 330. The movement over time of satellites 310 and 320 along different orbital paths, is depicted in three different inset illustrations 301, 302, and 303. The WTRU 330 may be present within a coverage area of satellite 310 during times shown at T1, T3, and T5. Inset illustration 301 shows the positions 310a and 320a of satellites 310 and 320, respectively, at time T1. At time T1, the WTRU 330 is within the coverage area of satellite 310 but outside of the coverage area of satellite 320 (i.e., experiencing a coverage gap with respect to satellite 320) and therefore may receive PRS only from satellite 310. Inset illustration 302 shows the movement of satellite 310 from position 310a to position 310b and the movement of satellite 320 from position 320a to 320b at time T2. At time T2, the WTRU 330 is within the coverage area of satellite 320 but outside of the coverage area of satellite 310 (i.e., experiencing a coverage gap with respect to satellite 320) and therefore may only receive PRS from satellite 320. Inset illustration 303 shows the movement of satellite 310 from position 310b to position 310c and the movement of satellite 320 from position 320b to 320c at time T3. At time T3, the WTRU 330 is within the coverage areas of both satellite 310 and satellite 320 and may receive PRS from each satellite.

During coverage gaps, such as those illustrated in inset illustrations 301 and 302 of FIG. 3, the WTRU 330 may move. In such a case, the network may be unable to verify the location of a WTRU due to infeasible or inaccurate satellite-based RAT dependent positioning (e.g., the WTRU cannot see enough satellites/collect enough measurements to perform positioning) and such inability to verify the WTRU's location may affect the service continuity. Solutions are needed for the NW to verify the WTRU's location consistently.

Contents of reports for WTRU location verification are described herein. In some examples, during or prior to location verification, the WTRU may determine to send measurements made on the received PRS and reference location (e.g., WTRU location determined from GNSS/GPS) to the network. The WTRU may determine to make measurements according to configured/determined RAT dependent positioning methods (e.g., methods such as DL-TDOA, RTT, DL-AoD). The network may determine the WTRU's location based on the reported measurements and cross-check with the reported reference location (e.g., the WTRU's location as determined from GNSS/GPS-based positioning methods). If the WTRU location determined from the reported measurements is within a threshold from the reference location, the network may determine that the WTRU's reported location is valid, and the network may offer service (e.g., call, data service, and/or continuity of RRC_CONNECTED state) to the WTRU.

In some examples, the WTRU may send a report to the network that contains various content. The content of a report may include measurements for RAT dependent positioning method(s) that are made on PRS(s) transmitted from TRPs/TPs (e.g., satellites, HAPS, mobile IAB, or other moving and/or aerial network nodes). Such measurements may be performed using metrics such as RSRP, RSTD, ToA, WTRU Rx-Tx time, AoA and/or AoD. Content may include timestamp(s) when the measurements are made where the timestamp may be expressed in terms of absolute (e.g. UTC)/relative time with respect to a reference time. Content of a report may include IDs (e.g., indices) of TRPs/TPs (e.g., satellites) from which the WTRU received PRS(s) and/or made measurements on the received PRS(s). Content of a report may include an index of a PRS resource the WTRU measured (e.g., PRS resource ID). Content of a report may include an LOS/NLOS indicator which may include hard (e.g., 1 or 0) or soft (e.g., 0, 0.1, 0.2, . . . , 1) values that indicate a likelihood of LOS/NLOS. Content of a report may include reference locations such as estimate(s) of WTRU locations obtained from GPS/GNS and/or sensors. Content of a report may include timestamp(s) indicating when the estimates of WTRU locations using GPS/GNSS are obtained. Content of a report may include information indicating uncertainties related to measurements/estimates of WTRU locations where the uncertainty is expressed in terms of range or standard deviation (e.g., expressed in meters/kilometers, seconds, degrees, number of symbols, dBm, dB). Content of a report may include information referencing one or more TRP/TP/PRS with respect to which RSTD is computed. Content of a report may include information referencing a reference PRS index (e.g., an ID) with respect to which RSTD is computed.

The WTRU may report at least one of the above measurements/information/content to the network based on the request from the network. In some examples, the WTRU may determine to report measurements made on the received PRS and location information obtained from the GNSS at a verification occasion.

A verification occasion and actual verification occasions may be defined as follows. A verification occasion may be the occasion at which the WTRU is configured to report location estimates obtained from RAT dependent positioning method and GNSS positioning. An actual verification occasion may be defined as the occasion at which the WTRU reports location estimates obtained from RAT dependent positioning method and GNSS positioning.

In some examples, the WTRU may be configured to make measurements at a preconfigured time, expressed in time units (e.g., symbols/slots/frames/seconds) before the occasion. For example, the WTRU may be configured to make measurements N slots before the verification occasion. The preconfigured time may be based on WTRU capability. If the WTRU cannot make measurements from the configured TRPs or minimum number of TRPs (e.g., satellites), the WTRU may not send a report to the network.

In some examples, the WTRU may receive configuration information for a verification window where the configuration information includes one or more parameters. The one or more parameters may include a start time expressed in terms of time units (e.g., absolute time, relative time with respect to a reference time, symbol/slot/frame index). The reference time may be based on an occasion/event, e.g., transmission/reception of a message to/from the network, transmission of one or more messages that may be used in a RACH procedure (e.g., msg1/msg3/msgA) and/or reception of one or more messages that may be used in a RACH procedure (e.g., msg2/msg4/msgB). The one or more parameters may include an end time expressed in terms of time units (e.g., absolute time, relative time with respect to a reference time, symbol/slot/frame index). The one or more parameters may include a duration of a window expressed in terms of time units (e.g., seconds, hours, symbols, slots, frames).

The configuration information for a verification window may be received via one or more of: system information (e.g. within SIB19, SIB31, SIB32); RRC signaling; an LPP message; one or more MAC CEs; or any other logically equivalent messages. In some examples, a WTRU may receive the configuration information in multiple messages. For instance, a WTRU may receive an initial default configuration via a first message (e.g. via system information) and then receive a dedicated configuration or configuration information via a second message (e.g. via RRC configuration). The WTRU may prioritize the configuration provided via the dedicated configuration.

In some examples, the WTRU may determine parameters related to WTRU location verification (e.g., periodicities of verification occasions, start/end time of verification window) from one or more broadcast transmissions from the network (e.g., SIBs) which may associate RACH occasion and the parameters related to WTRU location verification. The WTRU may send a preamble associated with the RACH occasion. The WTRU may receive information indicating an association between the preamble sequence and RACH occasion via one or more messages broadcasted by the network (e.g., SIB). In some examples, the WTRU may be preconfigured by the network with the association.

During the verification window, the WTRU may determine to perform WTRU location verification at configured periodic occasions. The periodicity of the occasions may be configured by the network and/or determined by the WTRU.

The WTRU may receive an activation/deactivation command for the verification window from the network (e.g., LMF, base station) via a LPP message, RRC, MAC-CE, DCI, for example, or any other logically equivalent signaling. The WTRU may send a request to activate or deactivate the verification window.

Configuration information for a verification window may be specific to a cell and/or network node (e.g. a satellite or base station). The WTRU may apply received configuration or received configuration information for the duration of connection to the cell and/or network node unless otherwise indicated (e.g. upon reception of further configuration information (e.g., a second configuration) or a deactivation command). If the WTRU is no longer connected to the cell and/or network node, the WTRU may assume that the configuration information is no longer valid. The WTRU may then, for example, apply default configuration information, apply a second configuration (e.g. received within a HO command or system information originating from the new cell/network node) or deactivate verification.

Embodiments for configuration of RAT dependent positioning methods are described herein. The WTRU may receive configurations, configuration information, and/or assistance information (e.g., PRS resource index (ID) to measure, PRS resource set ID, frequency layer index, bandwidth, PRS configuration information) for the RAT dependent positioning methods used to obtain measurements for PRS. The WTRU may determine the positioning method based on the configuration information received from the network (e.g., base station, LMF). The WTRU may determine to use the positioning method used for a previous occasion (e.g., the last occasion) to make measurements for WTRU location verification.

The WTRU may determine to use a positioning method for WTRU location verification based on the configuration or assistance information received from the network. For example, the WTRU may determine the positioning method to use for WTRU location verification based on the number of satellites configured for the WTRU. For example, if the assistance information contains ephemeris information for one satellite, or configuration indicates to use one satellite, the WTRU may determine to use a RTT positioning method. In some examples, if the WTRU is configured with more than one satellite, the WTRU may determine to use DL-TDOA based positioning method.

In some examples, if the WTRU determines that only one satellite is observable based on ephemeris information and/or the WTRU's location determined based on GNSS, the WTRU may determine a positioning method that requires one satellite (e.g., RTT based positioning method). If the WTRU determines that more than one satellite is observable based on for example, a remaining time duration within a window (e.g., a window defined by the parameter t-service), one or more cell reference point(s), ephemeris for one or more satellites and/or WTRU location determined based on GNSS, the WTRU may determine the positioning method that can use measurements made on PRS for more than one satellites (e.g., DL-TDOA, DO-AoD).

In some examples, the WTRU may be configured or preconfigured with a rule that associates a minimum number of TRPs (e.g., satellites) and positioning methods (e. g, four for DL-TDOA, one for RTT-based positioning method). Based on the configured or preconfigured rule, remaining time duration within a window for service in the current area (e.g., a window defined by the parameter t-service), one or more cell reference point(s), and/or one or more satellite ephemeris and/or WTRU location determined based on GNSS, the WTRU may determine the positioning method.

In some examples, the WTRU may be configured with more than one positioning method (e.g., DL-TDOA and DL-AoD, DL-AoD and RTT-based positioning method). Based on a remaining time duration within a window for service in the current area (e.g., a window defined by the parameter t-service), one or more cell reference point(s), and/or one or more satellite ephemeris and/or WTRU location determined based on GNSS, the WTRU may determine to use more than one positioning methods for determining the WTRU location (e.g., a combination of DL-TDOA and DO-AoD).

The WTRU may determine TRPs (e.g., satellites) to use based on ephemeris information and/or WTRU location determined based on GNSS. The WTRU may use one or more criteria to select TRPs. One criterion may be that an RSRP of a PRS measured from the TRP is above (or equal to) a threshold, which may be configured or preconfigured. Another criterion may be that a soft/hard LOS indicator associated with the TRP is above (or equal to) a preconfigured threshold for a soft LOS indicator may take a value of [0, 0.1, . . . 0.9, 1], for example, and a hard LOS indicator may be 1 or 0. Another criterion may be that a level of uncertainty related to measurements (e.g., TDOA, ToA, AoA, AoD, WTRU Tx-Rx time) is below (or equal to) a threshold that is configured or preconfigured. Another criterion may be that a level of uncertainty related to expected measurements (e.g., expected TDOA, expected ToA, expected AoA, expected AoD, expected WTRU Rx-Tx time) is below (or equal to) a preconfigured threshold. Another criterion may be the remaining time duration within a window for service within the current area (e.g., a window defined by the parameter t-service) of the cell originating from the TRP. Another criterion may be whether the a window for service within the current area by the current serving cell and a start of a window for service within the neighboring cell overlap (e.g. whether there is discontinuous coverage). Another criterion may be the distance from the WTRU to a cell reference point of the cell originating from the TRP.

In some examples, the WTRU may be configured or preconfigured to only use satellites with certain characteristic(s) for a given position method. For example, a WTRU may only use satellites for certain methods, e.g. DL-TDOA, multi RTT, or DO-AoD methods, having one or more of the following characteristics: a GEO or LEO classification; a specific orbital height or range of orbital heights; movement at a given speed or range of speeds; movement in a specific direction or range of directions; utilizing earth-fixed or earth-moving beams; or with a specific beam/cell diameter or range of diameters.

A WTRU may be configured with a default positioning method. The default positioning method may be configured, e.g., by the network. The WTRU may determine to use a default positioning method if one or more conditions is satisfied. A condition may be that the WTRU cannot observe the minimum number of satellites (e.g., RSRP of PRS transmitted from the satellite is below the threshold) for the configured positioning method (e.g., if the WTRU is configured with DL-TDOA, the minimum number of satellites required for positioning may be four). A condition may be that the WTRU did not receive assistance information/configurations for a positioning method. A condition may be that the WTRU is indicated to use the default positioning method.

If the WTRU cannot determine any positioning method (e.g., due to no visible satellites), the WTRU may determine to send an indicator/message via RRC, LPP message, MAC-CE, UCI to the network, indicating that the WTRU is unable to perform WTRU location verification. In one example, if the WTRU cannot determine any positioning method due to being located in an NTN coverage gap, the WTRU may, for example, send an indication through an alternative connection type (e.g. via a terrestrial network) and/or may wait until NTN coverage resumes and send the indication to the incoming cell. If NTN coverage remains available but no suitable satellites/TRPs are available for positioning, the WTRU may send the indication to the serving and/or available NTN cell. The WTRU may send the indicator/message if the WTRU receives a request from the network to perform WTRU location verification.

Various aspects of the WTRU's preparation for location verification are described herein. In some examples, the WTRU may be configured with or receive configuration information indicating a preparation duration (e.g., K slots). The preparation duration may be used by the WTRU to prepare to make measurements/location estimation via GNSS. For example, the WTRU may require or benefit from time to establish synchronization with GNSS/GPS navigation satellites. The WTRU may need to establish synchronization with TRPs/satellites from which one or more PRSs may be transmitted.

In some examples, when the WTRU reports the determined periodicity to the network, (e.g., during random access or WTRU capability transfer) the WTRU may determine to perform WTRU location verification after the preparation duration elapses. In another example, the WTRU may determine the preparation duration based on the WTRU's capability. If the WTRU determines the periodicity from a list of periodicities configured by the network, the WTRU may determine to perform WTRU location verification after the preparation duration elapses.

The WTRU may receive an ACK/NACK (which may constitute approval/rejection) for the determined periodicity of actual verification occasion by the WTRU. Once the WTRU receives the ACK message, the WTRU may determine that the actual verification may be carried out, for example, after the reception of the ACK message when an amount of time equal to the determined preparation duration elapses. In one example, the start time of the preparation duration may be the time when the WTRU receives ACK from the network.

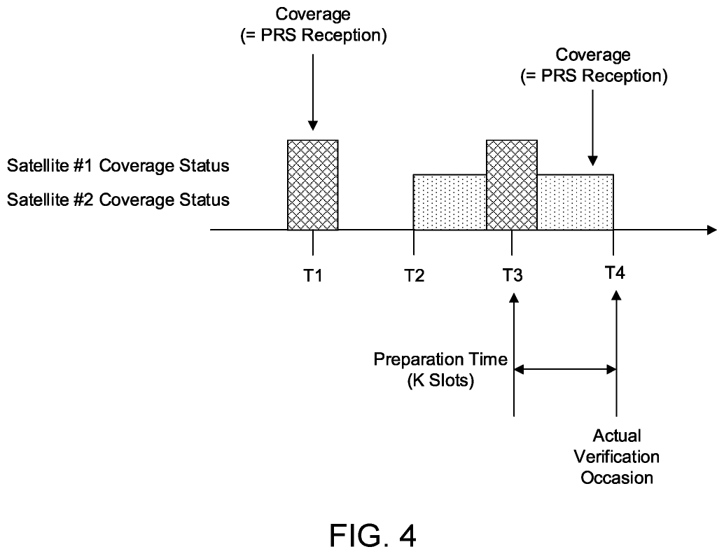

FIG. 4 is a diagram illustrating an example of preparation time where an actual verification occurs after measurements are performed based on received PRS(s). As shown in FIG. 4, a WTRU may be within the coverage area of a first satellite (denoted as Satellite #1 in FIG. 4) at time T1 and T3. The WTRU may be within the coverage area of a second satellite (denoted as Satellite #2 in FIG. 4) between time T2 and T4. While the WTRU is within the respective coverage areas of satellite #1 and satellite #2, the WTRU may receive and measure PRS from one or both satellites. As is further illustrated in FIG. 4, the WTRU may be configured with (or have determined) a preparation duration equal to K slots from T3, at which time the WTRU is simultaneously within the coverage of satellite #1 and satellite #2. The WTRU may apply the preparation duration after the WTRU makes measurements on PRS from both satellite #1 and satellite #2.

Methods for determining a start time of a verification procedure are described herein. The WTRU may determine a start time of the verification procedure (e.g., a first verification occasion within a set of periodic/semi-static verification occasions, or a verification occasion within a set of aperiodic verification occasions) based on one or more events. One event may be that the WTRU receives, from the network, configuration information regarding a start time of the verification procedure (e.g., relative time with respect to the reference time (e.g., reception of the configuration), absolute time).

Another event may be that the WTRU determines or is configured with a preparation time and the WTRU determines the start time of the verification procedure based on a reference time (T) and the preparation time (Tp). For example, the start time may be T+Tp. The WTRU may determine the reference time based on at least one of the following: reception of one or more configuration message (e.g., via RRC signaling, LPP messages, or any other logically equivalent signaling) from the network, reception of an ACK message, or measurements performed on PRS for the minimum number of satellites or for a number of configured satellites.

If the WTRU is configured to us the RTT-based or UL-TDOA positioning methods, the WTRU may determine start/end time of the verification procedure based on the SRS configurations configured by the network. For example, the WTRU may determine to start the verification procedure based on a start time of a transmission of periodic or semi-persistent SRS transmissions. The WTRU may determine to terminate the verification procedure when the semi-persistent PRS transmissions is deactivated by the network (or the WTRU deactivates the semi-persistent PRS transmission) via a MAC-CE or another logically equivalent message. The WTRU may send a request to the network to deactivate SRS transmission. In another example, if the WTRU receives a termination command form the network (via RRC signaling or other logically equivalent signaling), the WTRU may determine to terminate the verification procedure.

Methods for determining the success or failure of WTRU location verification are described herein. In some examples, the WTRU may determine that WTRU location verification was successful when the WTRU receives a message from the network after the WTRU sends the report containing information for WTRU location verification (e.g., measurement reports, WTRU locations determined by GNSS/GPS-based methods). The WTRU may determine that WTRU location verification is successful based on one or more conditions. One condition may be the receipt of a message that indicates that the WTRU location is verified. One condition may be the reception of a grant from the network for the request from the WTRU that requires WTRU location verification (e.g., a request to make a call, a transition to RRC_CONNECTED/RRC_INACTIVE state, and/or the maintenance of RRC_CONNECTED state). For example, the WTRU may make a request to make a call. The WTRU may send the report containing information for WTRU location verification. In response to the request, the WTRU may receive a grant from the network to make the call. In another example, the WTRU may make a request to transition to the RRC_ INACTIVE state. The WTRU may send the report containing information for WTRU location verification. In response for the request, the WTRU may receive a grant from the network to transition to the RRC_INACTIVE state.

The WTRU may determine that WTRU location verification failed based on one or more conditions. One condition may be the receipt of a message that indicates that the WTRU location failed. One condition may be that the WTRU does not receive the grant from the network for the request from the WTRU that requires WTRU location verification (e.g., a request to make a call, transition to RRC_CONNECTED/RRC_INACTIVE state, maintenance of RRC_CONNECTED state) within a preconfigured time from the time the WTRU sent a report containing measurements and WTRU location determined from GNSS/GPS.

Methods for determining the success or failure of a WTRU location verification procedure are described herein. In some methods, the WTRU may determine the verification procedure is successful if the WTRU determines actual verification occasions, makes measurements for reporting, and/or sends the measurement report at the actual occasions. In some examples, the WTRU may determine that the verification procedure is successful according to one or more criteria. One criterion may be that the WTRU makes measurements based on PRS from the configured and/or minimum number of TRPs (e.g., satellites), and/or determines its location based on GNSS/GPS before the preconfigured time before the actual verification occasion. Another criterion necessary for a successful location verification procedure may be that the WTRU sends a report containing information required for WTRU location verification (e.g., measurements made on one or more PRS(s) and/or WTRU location(s) determined from GNSS/GPS) at the actual verification occasion. Another criterion may be that the WTRU determines an actual verification occasion if the WTRU receives a request from the network to determine the verification occasion. Another criterion may be that the WTRU determines an actual verification occasion if the WTRU receives a request from the network to determine the verification occasion during the specified time interval/duration (e.g., time limit to determine the verification occasion).

Various consequences of a failure of a WTRU location verification or WTRU location verification procedure are described herein. In some examples, if the WTRU location verification or verification procedure fails, the WTRU may make one or more determinations. One determination may be that the WTRU is to transition into an IDLE state. In such case, the WTRU may determine to perform an initial access procedure to attempt to establish a connection to the network. Another determination may be that the WTRU receives a rejection message associated with a service the WTRU is subscribed to (e.g., call). Another determination may be that the WTRU is prohibited from performing UL transmission(s) and/or performing an initial access procedure (e.g., the WTRU may not receive grants for UL transmissions). The prohibition against UL transmission(s) or initial access may be set for a preconfigured time (e.g., N frames/slots/symbols/seconds). Another determination may be that the WTRU sends a request at the preconfigured time after the WTRU sends a request (e.g., N frames/slots/symbols/seconds). Another determination may be that the WTRU receives limited service from the network (e.g., the amount of bandwidth allocated for the WTRU is limited to the preconfigured amount, modulation/coding rate is limited to the preconfigured set, configurable frequency ranges/center frequencies are limited to the set).

Methods for determination of the TRPs (e.g., satellites) for which to perform location verification are described herein. In some examples, for WTRU location verification, the WTRU may determine the TRP(s) (e.g., satellite(s)) from which to receive PRS from based on one or more conditions. If one or more of such conditions are satisfied for a particular TRP, the WTRU may determine to perform location verification in connection with said TRP. One condition may be that the measurement (e.g., RSRP, RSRP per path) of a PRS transmitted from the TRP is above or equal to the preconfigured threshold. Another condition may be that the ToA of a PRS from a TRP is within a configured or preconfigured threshold from the configured verification occasion(s). For example, if the WTRU is configured with periodic verification occasions, each occasion may be within the preconfigured threshold from ToA.

Another condition may be the positioning method the WTRU is configured with. For example, if the WTRU is configured with an RTT-based positioning method, the WTRU may determine the number of satellites to select is at least one. If the WTRU is configured DL-TDOA, the WTRU may determine that the minimum number of satellites to select is four. The WTRU may determine a group of satellite(s) based on at least one of the aforementioned criteria.

Another condition may be that the WTRU location is estimated via GNSS/GPS/sensors. The WTRU may determine which satellites to make measurements based on the WTRU location or NTN/terrestrial cells the WTRU is associated with.

Another condition may be a number of satellites to be used for location verification. For example, the WTRU may be configured with the number/minimum number of satellites to make measurements on PRS. Based on the configured number of satellites, the WTRU may determine which satellite to take measurements from.

Methods for transmission of SRS for WTRU location verification are described herein.

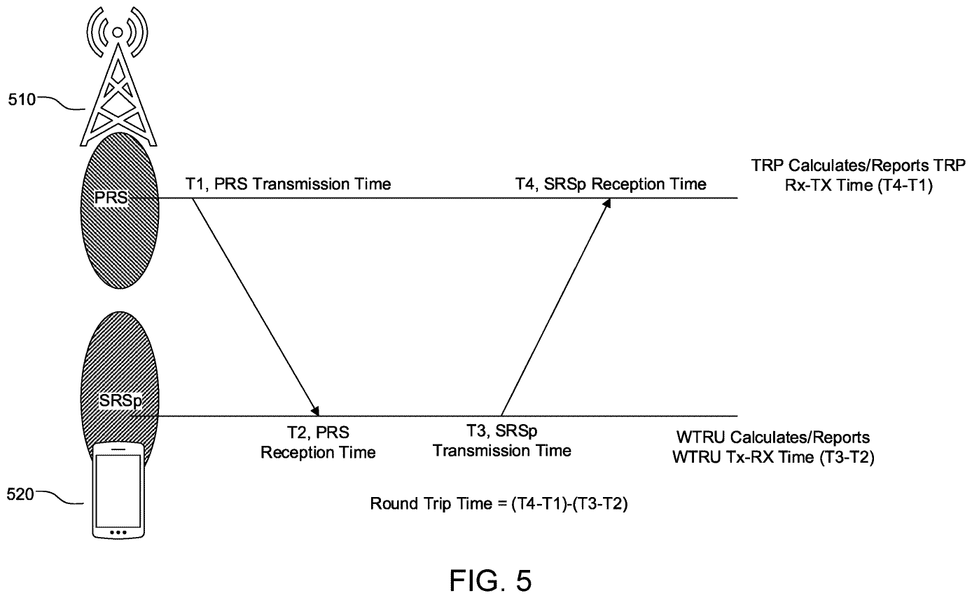

FIG. 5 is a diagram illustrating an example procedure for RTT-based positioning. As shown in FIG. 5, a TRP 510 may be configured to transmit PRS(s) and receive sounding reference signals for positioning (SRSp) from a WTRU 520. The WTRU 520 may be configured to receive PRS(s) from TRP 510 and to transmit SRSp(s) to the TRP 510. As shown in FIG. 5, the TRP 510 sends a PRS transmission at T1. The WTRU 520 may receive the PRS transmitted by the TRP 510 at T2. At T3, the WTRU may transmit an SRSp to the TRP. The WTRU 520 may calculate and/or report T3-T2, which may indicate a time difference between the reception of the received PRS and the transmitted SRSp (i.e., the WTRU Tx-Rx time) to the network (e.g., the TRP 510). The network (e.g., the TRP 510) may evaluate the time difference between the transmission of the PRS (by the TRP 510) and the reception of the SRSp (by the TRP 510), which may be referred to as the TRP Tx-Rx time. The TRP 510 may be configured to report the TRP Tx-Rx time to an entity (e.g., LMF). Additionally, the network (e.g., the TRP 510) and/or the WTRU may be configured to determine the RTT by calculating a difference between the TRP Rx-Tx time and WTRU Tx-Rx time, for example, by evaluating (T4-T1)−(T3-T2). The network (e.g., the TRP 510) and/or the WTRU may be configured to report the calculated RTT to another entity (e.g., LMF).

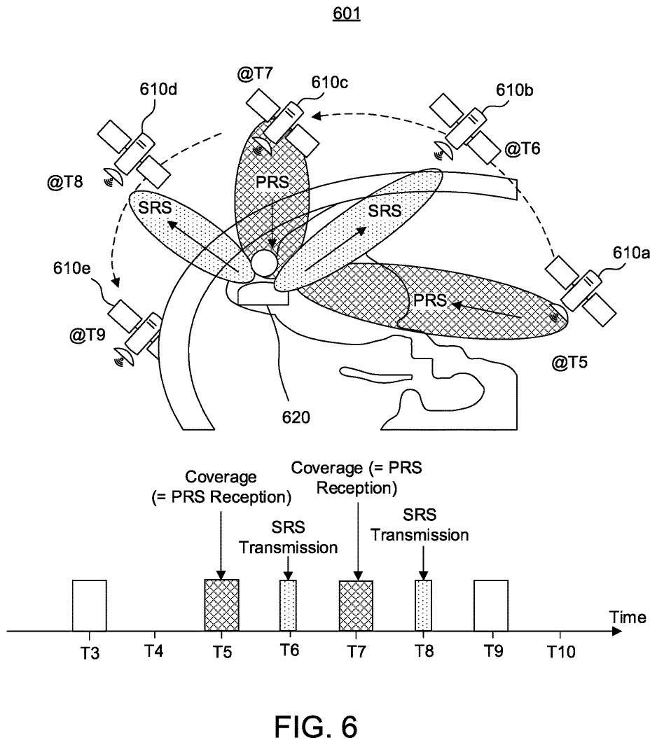

FIG. 6 is a diagram illustrating a relationships between satellite positions, a WTRU's position, and the transmission and reception of PRS and the transmission and reception of SRS (e.g., SRSp). As shown in FIG. 6, a satellite may move over time along an orbital path, reaching positions 610a, 610b, 610c, 610d, and 610e at time instances T5, T6, T7, T8, and T9, respectively. The coverage area of the satellite 610 may change in accordance with the position of the satellite 610 over time. A WTRU 620 may lie within the coverage area during only a portion of the time instances shown, and the WTRU 610's ability to receive PRS from the satellite 610 and transmit SRS to the satellite 610 may be affected.

In the example shown in FIG. 6, WTRU 620 receives PRSs from a satellite 610 (whose position is illustrated in FIG. 6 by element 610a) at t=T5 and t=T6, and transmits SRS (e.g., SRSp) to the satellite 610 at t=T6 and t=T8. Substantially in accordance with one or more methods described herein, the WTRU 620 may determine actual verification occasions during two intervals (e.g., after the WTRU 620 transmits SRS to the satellite 610). The first interval may be between T6 and T7. The second interval may be between and T8 and T9. The WTRU 620 may be configured to transmit SRSp at configured repetition factors (e.g., repetition factor=two). Although not explicitly shown in the inset illustration 601 of FIG. 6, the satellite 610 may be configured to transmit PRS at T3 and/or T9 (e.g., periodically or aperiodically), but the WTRU 620 may be unable to receive the PRS, for example, due to NLOS.

In some examples, the WTRU may determine a successful WTRU location verification based on at least one or a combination of conditions. One condition may be that the WTRU is configured with a grant (e.g., a configured or dynamic grant) to transmit SRS and/or send a measurement report to the network by the time limit (e.g., a preconfigured time before the actual verification occasion). The measurement report may include at least WTRU Tx-Rx time. Another condition may be that the WTRU is configured with one or more grants (e.g., configured or dynamic grants) to transmit SRS at configured repetition occasions and/or at the minimum/required number of repetition occasions. Another condition may be that the WTRU is configured with a grant (e.g., a configured or dynamic grant) to send a measurement report to the network by the time limit (e.g., preconfigured time before the actual verification occasion). Another condition may be that the WTRU is configured with a grant (e.g., a configured or dynamic grant) within the preconfigured threshold (e.g., expressed in time units such as seconds, symbols, slots, frames) from the time the WTRU received PRS. For example, referring to the example shown in FIG. 6, if T3-T2 is greater than the preconfigured threshold, the WTRU may determine that the WTRU location verification is not successful. Another condition may be that the WTRU transmits SRS at scheduled grants/occasions. The WTRU may transmit SRS at scheduled grants/occasions. If the WTRU is configured, e.g., by the network, with a higher priority level for SRS compared to other channels, the WTRU may determine to prioritize the transmission of SRS when collision(s) between SRS resources and other channels (e.g., time/frequency resources of PUCCH/PUSCH and those of SRS) overlap.

In some examples, the WTRU may determine failure has occurred in verification location when the WTRU cannot transmit SRS by the configured time before the actual verification. The WTRU may not be provided grants/occasions by the network to transmit SRS in such cases. In another example, the WTRU may need to prioritize transmissions of other channels (e.g., PUCCH or PUSCH) if transmission of other channels (e.g., PUCCH, PUSCH) are associated with higher priority level than SRS. In such cases, the WTRU may cancel one or more SRS transmissions. When the WTRU declares failure in location verification, the WTRU may skip to the next verification occasion for reporting. Alternatively, or additionally, the WTRU may send a report to the network that the WTRU location verification has failed due to cancelled/postponed transmission of SRS.

During a verification window, the WTRU may determine, from configuration information provided from the network, a priority level of SRS resources or transmissions. For example, the WTRU may determine that SRS transmitted during the verification period is higher than other channels (e.g., PUCCH, PUSCH). Thus, in case of collisions (e.g., time/frequency resources of PUCCH overlap with those for SRS), the WTRU may determine to prioritize one or more SRS transmissions if its priority level is higher than other channels.

Measurements for WTRU verification are described herein. The WTRU may make M measurements on PRS before an actual verification occasion. Similarly, the WTRU may transmit SRS at N occasions before an actual verification occasion. The WTRU may determine to report M measurements at each actual occasion or the WTRU may determine to process (e.g., average) the M measurements and report the processed measurement to the network.

Examples of PRS/SRS configurations are described herein. In some examples, a PRS configuration may contain or provide one or more parameters. Such parameters may include a number of symbols, a transmission power, a number of PRS resources included in PRS resource set, a muting pattern for PRS (for example, the muting pattern may be expressed via a bitmap), a periodicity, a type of PRS (e.g., periodic, semi-persistent, or aperiodic), a slot offset for periodic transmission for PRS, a vertical shift of PRS pattern in the frequency domain, a time gap during repetition, a repetition factor, a resource element (RE) offset, a comb pattern, a comb size, a spatial relation, QCL information (e.g., QCL target, QCL source) for PRS, a number of PRUs, a number of TRPs, an Absolute Radio-Frequency Channel Number (ARFCN), a subcarrier spacing, an expected RSTD, an uncertainty in expected RSTD, a starting Physical Resource Block (PRB), a bandwidth, a BWP ID, a number of frequency layers, a start/end time for PRS transmission, an on/off indicator for PRS, a TRP ID, a PRS ID, a cell ID, a global cell ID, a PRU ID, and/or an applicable time window. The WTRU may apply a PRS configuration or PRS configuration information, for example, under a condition that the current time is within an applicable time window.

In some examples, a configuration for SRS for positioning (SRSp) or an SRS configuration may include one or more of the following: a resource ID; comb offset values, cyclic shift values; a start position in the frequency domain; a number of SRSp symbols; a shift in the frequency domain for SRSp; a frequency hopping pattern; a type of SRSp (e.g., aperiodic, semi-persistent or periodic); a sequence ID used to generate SRSp, or other IDs used to generate SRSp sequence; spatial relation information, information indicating which reference signal (e.g., DL RS, UL RS, CSI-RS, SRS, DM-RS) or SSB (e.g., SSB ID, cell ID of the SSB) the SRSp is related to spatially where the SRSp and DL RS may be aligned spatially; QCL information (e.g., a QCL relationship between SRSp and other reference signals or SSB(s); a QCL type (e.g., QCL type A, QCL type B, QCL type D); a resource set ID; a list of SRSp resources in the resource set; transmission power related information; a pathloss reference information which may contain index for SSB, CSI-RS or PRS; a periodicity of SRSp transmission; and/or spatial information such as spatial direction information of SRSp transmission (e.g., beam information, angles of transmission), and/or spatial direction information of DL RS reception (e.g., beam ID used to receive DL RS, angle of arrival).

Common principles and observations applicable to the proposed solutions are described herein. Solutions described herein may be based on the principle that the WTRU may observe satellites periodically according to their ephemeris, and the WTRU may determine the timing of verification based on the ephemeris. The WTRU may also predict an interval during which the WTRU may not be able to make measurements on PRS. In addition, one or both of network/WTRU can determine verification occasions based on ephemeris information. The WTRU may report its location information determined based on GNSS information based on which the network can determine verification occasions.

Common benefits applicable to the proposed solutions are described herein. Using one or more proposed solutions, the network may be able to verify a WTRU's location consistently and securely, so that the network can offer the service to the WTRU securely even in the presence of the discontinuous coverage.

Various solutions addressing at least the above-described problems are described herein. Event based verification may be one such solution for location verification. A network may provide configuration information for utilizing RAT dependent positioning for network verified WTRU location in advance (e.g. when the WTRU initially performs or requests registration at a NTN).

In some examples, a WTRU may determine to report measurements for a RAT dependent positioning method and/or GNSS location based on one or more conditions. Such WTRU positioning triggering conditions may be understood as follows. Some cases may concern call initiation-based triggers. For such cases, the WTRU may initiate RAT dependent positioning if some or all of the following conditions are met. Such conditions may be that the WTRU's PCell is an NTN cell, that the WTRU has a stored RAT dependent positioning configuration, or that the user of the WTRU initiates a call.

Regarding the condition that the WTRU's PCell is an NTN cell, the WTRU may determine that the PCell is an NTN cell for example, via detection of an NTN-specific system information block (e.g. SIB19, SIB31, SIB32), explicit indication, and/or detection of other NTN-specific information (e.g. satellite ephemeris, t-service, pre-compensation timing information, cell reference point).

Regarding the condition that the WTRU has a stored RAT dependent positioning configuration, the RAT dependent positioning configuration for the NW verified WTRU location may be provided, e.g., by system information (e.g. as part of existing SIB such as NTN SIB or via a brand-new SIB), a RACH message (e.g. MSG2, MSG4 or MSGB), by MAC CE, by a dedicated RRC message, or by other logically equivalent signaling, which may be sent when the WTRU moves into NTN coverage (i.e. WTRU′ PCell is changed from TN cell to NTN cell.), for example, the dedicated RRC message may be a handover message such as an RRCReconfiguration message, which may include a target NTN cell information.

Regarding the condition that the user of the WTRU initiates a call, “a call” may refer to a mobile originated call (MO call), a mobile terminated call (MT call) or a data communication call, which may be used to exchange user data between a specific application working on the WTRU and the peer entity of the application. In some examples, when the WTRU attempts to establish a call, initiates a call or prior to making the call, the WTRU may initiate the initial access procedure (e.g., send a preamble, Msg1,MsgA, or another message related to access to the network) to establish a connection with the network. The WTRU may also indicate the content of the call (e.g., voice/data/video) to the network.

Some cases may concern other mobility event triggers. For these cases, the WTRU may initiate RAT dependent positioning if some or all of the following conditions are met. Such conditions may be that the WTRU's PCell is an NTN cell, that the WTRU has stored RAT dependent positioning configuration, and that specific mobility event criterion/criteria is/are met.

Regarding the condition that the WTRU's PCell is an NTN cell, the WTRU may determine that the PCell is an NTN cell for example, via detection of an NTN-specific system information block (e.g. SIB19, SIB31, SIB32), explicit indication, or detection of other NTN-specific information (e.g. satellite ephemeris, t-service, pre-compensation timing information, cell reference point).

Regarding the condition that the WTRU has stored RAT dependent positioning configuration, the RAT dependent positioning configuration for the NW verified WTRU location may be provided, e.g., by system information (e.g. as part of existing SIB such as NTN SIB or via a brand-new SIB), a RACH message (e.g. Msg2, Msg4, MsgB, or another message related to access), MAC CE, by a dedicated RRC message, or by another logically equivalent message, which may be sent when WTRU moves into NTN coverage (i.e. when the WTRU's PCell is changed from a TN cell to NTN cell). For example, the dedicated RRC message may be a handover message such as an RRCReconfiguration message, which may include information for handover to or communication with a target NTN cell.

A RAT dependent positioning configuration may incorporate the triggering condition described above that specific mobility event criterion/criteria is/are met (i.e., where the configuration specifies the cases in which the WTRU shall initiate RAT dependent positioning). For example, the configuration may stipulate that the WTRU shall initiate RAT dependent positioning if the WTRU moves X km (e.g. 5 km) from a location where the WTRU last performed positioning.

In some examples, “performing RAT dependent positioning” may mean that the WTRU returns measurements made on PRS transmitted by TRPs (e.g., satellites such as satellite 221 or 222 illustrated in FIG. 2, and/or UAVs) to the network (e.g., LMF, base station). The WTRU may receive configuration information for aperiodic/semi-persistent/periodic occasions to report measurements to the network. The occasions may be defined by timing at which the WTRU reports measurements. The timing for reporting measurements may be defined by absolute/relative time indications or by symbols/slots/frame indices, for example. The WTRU may receive configuration information (e.g., relative timing information) for a periodic occasion for measurement reporting/performing measurements. The WTRU may receive configuration information for semi-persistent reporting/measurements of received PRS, and the configuration information may indicate a start/end time and/or duration (e.g., expressed in seconds/number of symbols/slots/frames) of reporting/making measurements. Alternatively, or additionally, the WTRU may receive an indication of a time window during which the WTRU makes measurements on PRS. In some cases, the WTRU may receive information indicating a periodicity (e.g., expressed in the number of symbols/slots/frames) of reporting. The WTRU may receive an activation/deactivation command for semi-persistent reporting/measurements. The WTRU may send one or more requests to activate/deactivate semi-persistent reporting/measurements. For periodic measurement reporting/performing measurements, the WTRU may receive configuration information related to a periodicity of the reporting (e.g., expressed in the number of symbols/slots/frames), e.g., via a higher layer message (e.g., RRC, LPP) or other logically equivalent messages.

In some examples, the WTRU may receive configuration information for sending SRS to perform RAT dependent positioning. If the WTRU is not configured with the necessary information (e.g., SRS configuration) for sending SRS, the WTRU may send an indication to the network that the WTRU cannot perform WTRU location verification. If the WTRU has not been provided with one or more SRS configurations, the WTRU may determine to send a request to the network for SRS configurations. Alternatively, or additionally, if the WTRU is not configured with SRS configurations, the WTRU may determine to use a positioning method that does not require sending SRS (e.g., DL-TDOA, DL-AoD).

In some examples, a condition for performing positioning measurements (e.g. RAT-dependent positioning, GNSS) may be associated with scheduled location time (SLT) occasions. SLT occasions may correspond to one or more reference time occasions that may be configured in the WTRU by the network via LPP or RRC signaling, possibly for network verification of WTRU location. The WTRU may be configured to monitor the SLT occasions, and subsequently perform positioning measurements and/or report the measurements for network verification. For example, the SLT occasions may overlap with the verification occasions, possibly when SLT is configured in the WTRU by any of the CN or RAN entities in the network (e.g. a base station, LMF, AMF, SMF, OAM). Alternatively, or additionally, the SLT occasions may be independent or outside of the verification occasions, possibly when SLT occasions are configured by a LCS client/application.

The SLT occasions may be defined by different parameters including an SLT type (e.g. periodic, semi-persistent), SLT config ID/index, periodicity, a number of occasions, a start offset slot, a duration per occasion (e.g. number of symbols/slots), and/or a total time duration/window. The WTRU may be configured with one or more sets of SLT occasions, and any of the sets may be defined by different parameters (e.g. a periodicity of 100 ms may be used for SLT set 1 and periodicity of 1 s may be used for another SLT set 2), for example. The WTRU may receive an activation/deactivation indication (e.g. in RRC signaling, MAC CE, DCI, or another logically equivalent message) when any of the SLT sets are activated/deactivated.

As referenced above, regarding the condition that specific mobility event criterion/criteria is/are met for a WTRU to initiate RAT dependent positioning, the specific mobility event criterion/criteria may be defined by one or more events/occurrences. One event may be that the WTRU moves a certain distance (e.g. 5 km) from a specific point (e.g. the point at which the WTRU last performed RAT dependent positioning). In some examples, the WTRU may be configured with a threshold and the WTRU may determine that the difference (i.e., a distance) between the current WTRU location (e.g., determined by GNSS) and the specific point is above the threshold. In some examples, the WTRU may receive configuration information indicating the specific point (e.g., locations of positioning reference units, or a current WTRU location).

Another event may be that the WTRU moves a certain distance (e.g. 5 km) from a specific point (e.g. the point where the WTRU last performed RAT dependent positioning) but the distance between the current position and a second or another point is less than a threshold.

Another event may be that WTRU moves with a specific velocity and a certain amount of time elapses from when the WTRU last performed RAT dependent positioning. The specific velocity and/or the certain amount of time may be given, for example, by system information, a dedicated RRC message or hard-coded in specification(s). In some examples, the reference location/time from which the WTRU measures the distance or time, respectively, may be the location/time/occasion at which the WTRU reported the measurements for the received PRS or performed measurements on the received PRS. In some examples, the reference time may be the time when the WTRU received a grant for service/transmission or received an ACK/NACK message from the network confirming/not confirming the reception of a message (e.g., PUCCH/PUSCH) transmitted by the WTRU. In some examples, the reference time may be the time when a WTRU enters RRC_CONNECTED mode or establishes a connection with a network.

Another event may be that the WTRU performs HO (i.e., a change in PCell) N times, where N is given, for example, by system information, by a dedicated RRC message (N is a positive integer and it can be set to 1), or other logically equivalent signaling. Another event may be that the WTRU performs handover (PCell change) from a terrestrial network to a non-terrestrial network. Another event may be that the WTRU performs handover (i.e., PCell change) to a cell originating from a different land-based gateway (e.g. a feeder-link switch). Another event may be that the WTRU performs handover (i.e., PCell change) from a cell originating from or associated with one satellite to a cell originating from or associated with another satellite.

Another event may be that the WTRU performs handover (i.e., PCell change) to a cell originating from or associated with a different satellite constellation. A different satellite constellation may include, for example, satellites belonging to a different orbit, height, classification (GEO vs. LEO) or direction. The WTRU may determine that a satellite belongs to a different constellation, for example, via difference in ephemeris data or based on an explicit indication.

Another event may be that the WTRU performs handover (i.e., PCell change) to a cell that provides coverage after a discontinuous coverage gap. The WTRU may determine that the cell is providing coverage after a discontinuous coverage gap, for example, based on an explicit indication (e.g. an indication provided in a HO command), based on a temporary lack of coverage, or based on detection of a gap between a coverage window (e.g., represented by the parameter t-service) of the former serving cell and the start of coverage (i.e., represented by the parameter t-servicestart) of the incoming serving cell.

In some examples, the WTRU may determine timing of a verification occasion based on a type of the event. For example, the WTRU may be preconfigured with information such as a mapping table/configuration that associates the event and a maximum/minimum duration following the event, during which the WTRU may be expected to perform the WTRU location verification. The WTRU may determine the verification occasion based on the duration and ephemeris. For example, if the WTRU moves a certain distance that is above the threshold (e.g., 50 km), the WTRU may be configured to perform WTRU location verification within 5 hours after the mobility event (e.g., after the WTRU has moved more than the 50 km threshold). Based on the ephemeris information, the WTRU may determine the verification occasion, which may take place within 5 hours from the mobility event.

Methods to be performed upon a WTRU's failure to complete a verification procedure are described herein. If the WTRU cannot (or does not) perform the location verification within the configured duration from the event, the WTRU may perform one or more actions. In some examples, the WTRU may change RRC states, for example to RRC IDLE or INACTIVE state. The WTRU may perform such actions autonomously (e.g. without prior notification to the network) or may alternatively indicate to the network that the verification procedure has failed. The WTRU may then monitor for a network response, for example, an RRC Release message or RRC Release with suspend indication. In some examples, the network may provide an indication of an additional duration for the WTRU to complete the verification request prior to releasing the WTRU. This may be realized, for example, by providing a time to trigger indication along with the RRC Release or RRC release with suspend message.

In some examples, if the WTRU is unable to verify the WTRU location, the WTRU may maintain the connection; however, the WTRU may be restricted in the type of transmissions it may perform. For example, the WTRU may only transmit one or more types of transmissions. Some transmissions may include information related to connection maintenance (e.g. measurement results, measurement reports). Some transmissions may include HARQ feedback (e.g. ACK/NACK of received data) or HARQ retransmissions (e.g. based on reception of a retransmission grant). Some transmissions may be RACH (e.g. preamble transmission, Msg3, Msg5, or MsgA) transmissions or otherwise related to random access. Scheduling requests may be another type of transmission.

Some transmissions may carry data from a subset of logical channels. For example, the WTRU may be restricted to transmit data only to high priority logical channels. Some transmissions may carry emergency related messaging (e.g. related to CMAS, ETWS, or emergency calls).

If the WTRU falls back to an RRC IDLE/INACTIVE state, the WTRU may attempt to re-acquire necessary configurations and measurements to perform WTRU positioning verification. The WTRU may then attempt to re-start a connection, and may indicate during RACH that the cause for a previous connection failure is based on a location verification failure. For example, the WTRU may indicate the cause via a new connection set-up/resume cause, dedicated preamble selection, or within a RACH message (e.g. Msg3, Msg5, or MsgA).

In some examples, the network may bar the WTRU from the cell if the WTRU has failed one or more verification attempts, or if the verification procedure has not been performed on time. An example of barring the WTRU from the cell may be the case when the WTRU cannot connect to the cell (e.g., initial access fails) for a configured amount of time (e.g., N hours) and/or the cell does not support a WTRU class (e.g., Reduced Capability WTRU) or feature (e.g., non-terrestrial network access). The barring may be conditional on whether the WTRU has performed WTRU location verification (e.g. has performed the necessary measurements to complete verification), and if so the WTRU may re-access the cell.

In an exemplary procedure, a WTRU may perform event-based verification as follows. In a first step, the WTRU may receive assistance information (e.g., ephemeris information for one or more satellites, configuration information for RAT dependent positioning method (e.g., such as PRS and/or SRS configurations), or thresholds) from the network (e.g., LMF, base station) and keep the configuration. In a second step, the WTRU may perform a RAT dependent positioning method based on the stored RAT dependent positioning configuration provided, for example, in step 1 when certain conditions are met. The certain conditions may be one or more of the following: a user of the WTRU initiates a mobile originated call (MO call); the WTRU receives a paging message for mobile terminated (MT) call; the WTRU's serving NTN cell is changed; and/or the WTRU determines that WTRU moves for a certain distance, which may exceed a threshold provided, for example, at step 1.

In a third step, the WTRU may report a location determined by the RAT dependent positioning method and/or measurement reports (e.g., RSTD for DL-TDOA, RSRP, WTRU Rx-Tx time) when the information becomes available. The WTRU may initiate a certain service (such as MO call, MT call or user data transfer request). If applicable, the WTRU may transmit SRS to the TRP (e.g., a satellite). In the same report (or a different report), the WTRU may include the location estimate determined by GNSS-based methods.

In some examples, the WTRU may receive an indication of the minimum number of satellites for measurements from the network. In some examples, the WTRU may determine a time limit for the verification occasion (e.g., a time limit relative to the mobility event) based on an amount of distance over the threshold. For example, if the WTRU moved 100 km over the threshold, the WTRU may determine that the time limit for the verification occasion is 1 hour. If the WTRU moved 20 km over the threshold, the WTRU may determine that the time limit for the verification occasion is 6 hours.

In some exemplary procedures, a WTRU may perform mobility event-based verification based upon a time limit. If the WTRU determines that it moved further than the configured threshold, the WTRU may determine that it should perform WTRU location verification. In these procedure, the location verification must take place within the time limit starting from the mobility event. Otherwise, the WTRU may need to perform initial access to establish connection with the network.

In one or more steps of a procedure, the WTRU may receive assistance information (e.g., ephemeris information for one or more satellites, configuration information for RAT dependent positioning method), first and second thresholds (e.g., expressed in meters and hours, respectively) from the network (e.g., LMF, base station). In one or more steps of a procedure, the WTRU may detect that it moved a certain distance from the reference point (e.g., the reported location at the previous reporting occasion, cell center) that exceeds the first threshold. The detected movement may constitute a detected mobility event. In one or more steps of a procedure, the WTRU may determine the verification occasion based on the received ephemeris information. If the determined verification occasion is within the second threshold from the time of the detected mobility event, the WTRU may transmit verification information to the network at the determined verification occasion. The verification information may include, for example the location determined by the RAT dependent positioning method, a location estimate obtained from GNSS-based methods, and/or measurement reports (e.g., RSTD for DL-TDOA, RSRP) when the information becomes available. In one or more steps of the procedure, if the determined verification occasion occurs after preconfigured time from the time of the detected mobility event, the WTRU may perform initial access to establish a connection with the network.

In some exemplary procedures, in an emergency scenario, a WTRU may override network verification requirements. In one or more steps of a procedure, the WTRU may receive assistance information (e.g., ephemeris information for one or more satellites, configuration information for RAT dependent positioning methods), first and second threshold (e.g., expressed in meters and hours, respectively) from the network (e.g., LMF, base station, or a TRP) and the WTRU may keep the configuration information. In one or more steps of a procedure, if the WTRU determines that a verification procedure is necessary (e.g. event-based triggering, NW request), the WTRU may begin performing RAT-dependent verification. In one or more steps of the procedure, the WTRU may determine that the verification procedure has failed (e.g., the WTRU may be unable to determine the actual verification), and the WTRU may be suspended from performing one or more uplink transmissions (e.g., PUSCH transmission). In one or more steps of a procedure, the WTRU may detect that an emergency call is needed, and the WTRU may override suspension or data and or cell barring and may perform the emergency call (e.g., using the PUSCH).

In some examples, the WTRU may be configured with a priority level of a call. For example, an emergency call may be associated with a higher priority level than data communication call. Based on the priority level of the call, the WTRU may determine to make the call (e.g., send a request to the network to schedule resources for the call) even during the period the WTRU is prohibited to making the call.

In some exemplary procedures, a WTRU may perform priority based overriding of network verification requirements. In one or more steps of a procedure, the WTRU may receive assistance information (e.g., ephemeris information for one or more satellites, configuration information for RAT dependent positioning method), first and second thresholds (e.g., expressed in meters and hours, respectively) from the network (e.g., LMF, base station, or TRP) and may keep the configuration. In one or more steps of a procedure, if the WTRU determines that a verification procedure is requested (e.g. based on event-based triggering, or a network request), the WTRU may begin performing RAT-dependent verification. In one or more steps of a procedure, the WTRU may determine that the verification procedure has failed (e.g., when the WTRU cannot determine the actual verification), and that the WTRU is suspended from performing one or more uplink transmissions (e.g., PUSCH transmissions) for a configured duration (e.g., a configured prohibition duration). In one or more steps of a procedure, if the WTRU determines it should perform an uplink transmission having a high priority (e.g., scheduling request), the WTRU may send a scheduling request for the transmission during the prohibition duration.

Described herein are methods for WTRU location verification that may be performed before a WTRU transitions into an INACTIVE or IDLE state. In such methods it may be beneficial for the WTRU to retain valid WTRU location as long as possible while the WTRU is in an IDLE/INACTIVE state. If the WTRU determines that the WTRU location needs to be verified during an IDLE/INACTIVE state, the WTRU may need to transition into an RRC_CONNECTED state, which may consume battery power at the WTRU. Therefore, it may be beneficial for the WTRU to perform WTRU location verification before the WTRU transitions into the IDLE/INACTIVE state.

In some examples, the WTRU may determine to perform WTRU location verification (e.g., perform measurements and/or transmit the measurement report to the network) when the WTRU changes the state (e.g., from RRC_CONNECTED to RRC_INACTIVE, or from RRC_INACTIVE to RRC_CONNECTED). For example, the WTRU may determine to perform measurements once the WTRU determines that the WTRU is transitioning into the RRC_INACTIVE state (e.g., the WTRU receives an RRC message such as RRC release message from the network, the WTRU may send a request to transition into the INACTIVE state). For example, the WTRU may determine to make measurements based on one or more received PRS after the WTRU receives the RRC release message from the network. The WTRU may determine to send the measurement report to the network after the RRC release message. The WTRU may make measurements following a DRX pattern (e.g., the WTRU may take one or more measurements during an “on” state within a DRX cycle). In another example, the WTRU may send a measurement report to the network following the DRX pattern (e.g., the WTRU send the measurement report during “on” state during the DRX cycle) or using small data transmission (SDT) methods.

In some examples, the WTRU may determine the occasion to transmit the measurement report (e.g., a report that contains GNSS location and measurements) or make measurements from a message received from the network (e.g., if an RRC release message contains an occasion to make measurements or report measurements to the network).

In some examples, the WTRU may determine the occasion to transmit the measurement report (e.g., a report that contains GNSS location and measurements) or make measurements from the message received from the network while the WTRU is in RRC_CONNECTED state.

The WTRU may be provided with dedicated resources to perform a RACH procedure (i.e., transmits a RACH) for the purposes of location verification. For example, the WTRU may be configured with a specific preamble or resume cause to prevent the network from erroneously transitioning the WTRU into the RRC_CONNECTED state. In some solutions, if the WTRU performs a RACH procedure for the purpose of transmitting WTRU location information (e.g. PRS measurements) and receives an indication to transition to RRC_CONNECTED state, the WTRU may reject the transition and remain in the current state. The ability to reject a connection may be enabled/disabled, for example, via system information.

In some examples, if the WTRU determines that the WTRU is in an INACTIVE state, the WTRU may use the SRS configurations that the WTRU was configured with while the WTRU was in RRC_CONNECTED state. In some examples, the WTRU may receive SRS configuration information in an RRC message from the network (e.g., via an RRC_RELEASE message).

In an exemplary procedure, a WTRU may perform location verification before entering an INACTIVE state. In one or more steps of a procedure, the WTRU may receive assistance information (e.g., ephemeris information for one or more satellites, configuration information for RAT dependent positioning methods) from the network (e.g., LMF, base station, or TRP). In one or more steps of a procedure, the WTRU may determine one or more verification occasions based on the RRC_Release message from the network that contains configurations for verification (e.g., providing relative timing of verification occasions, N slots, and/or a verification validation period). In one or more steps of a procedure, the WTRU may make measurements of the PRS. In a fourth step, the WTRU may determine its location based on GNSS. In one or more steps of the procedure the WTRU may report both the measurements and the WTRU's location as estimated via GNSS at the occasion configured by the network. In one or more steps of the procedure, if the WTRU receives a grant confirming verification, the WTRU may enter the INACTIVE state and determines that the WTRU location is valid for the validation period. Otherwise, the WTRU determines to enter an IDLE state.

Priority rules applicable for WTRU location verification are described herein. In some examples, the WTRU may be configured with a priority level of measurements for WTRU location verification. If the WTRU determines that the priority level is high, the WTRU may determine to perform measurements for the purpose of WTRU verification despite the WTRU being configured to skip measurements. The WTRU may receive an indication of the priority level for measurement and/or measurement reporting from the network (e.g., LMF, base station, or TRP).

For example, the WTRU may be configured with a threshold for location based measurements (e.g., inter-frequency cell/intra-frequency measurements). The WTRU may not perform inter frequency cell or intra-frequency measurements if, for example, the location of the WTRU is within the threshold from the reference point while the WTRU is in INACTIVE state (e.g., for conservation of power in the WTRU battery). However, even if the location is valid and the WTRU is located within the threshold from the reference point (or any rules/conditions to skip measurements is satisfied), if the priority level associated with WTRU location verification is high (or higher than the priority level associated with skipping measurements) and one of the preconfigured rules (e.g., the WTRU location is outside of a threshold compared to a reference point, and/or the elapsed time compared to the reference time is greater than the threshold) for reporting measurements for location verification requires the WTRU to make measurements (e.g., to maintain validity of the WTRU location), the WTRU may determine to make measurements (e.g., PRS measurements, inter-frequency cell/intra-frequency measurements) regardless of the state of the WTRU (e.g., regardless of whether the WTRU is in RRC_CONNECTED, INACTIVE, or IDLE mode).

In some examples, the WTRU may be configured by the network with a priority level for a measurement report for location verification. According to the configured priority level, the WTRU may determine that the measurement report may be associated with a higher or lower priority level compared to other channels (e.g., PUSCH, PUCCH).

Conditions for transitioning into RRC_CONNECTED mode for WTRU verification are described herein. In some examples, the WTRU may determine to make a transition to RRC_CONNECTED if at least one of the aforementioned conditions to perform WTRU verification is met while the WTRU is in IDLE/INACTIVE state. For example, if the WTRU is in IDLE state, and the WTRU determines that the elapsed time since the last occasion the WTRU's location is verified is past, the WTRU may determine to perform initial access so that the WTRU can report measurements made on PRS to the network while the WTRU is in RRC_CONNECTED state.

In some examples, the WTRU may determine to transition into RRC_CONNECTED mode (e.g., via performing initial access, sending a request to the network to make the transition into RRC_CONNECTED mode) if, for example, at least one of the aforementioned conditions to perform WTRU verification is met, and if the WTRU is in INACTIVE state. In some examples, the WTRU may determine to make the transition into RRC_CONNECTED mode, e.g., if the WTRU determines that the size of the measurement report for WTRU location verification purpose is greater than the preconfigured threshold.

In some examples, the WTRU may determine that at the verification occasion (e.g., broadcasted by the network), the WTRU may determine to perform initial access so that the WTRU may report or so that the network may verify the WTRU location through the initial access procedure. For instance, the WTRU may report its location information to the network via Msg3, Msg5, and/or the WTRU may identify its location information via the preamble, where each preamble may be associated with an area/cell ID.

Solutions for network initiated periodic verification are described herein. In some examples, the WTRU may determine verification occasions configured by the network. The WTRU may be configured, semi statically (e.g., via RRC, LPP or other logically equivalent signaling), with a periodicity for verification occasions and/or start time of a first verification occasion. The WTRU may determine one or more actual verification occasions based on ephemeris of one or more satellites or a service timeframe (e.g., denoted by the parameter t-service) of the current serving cell.

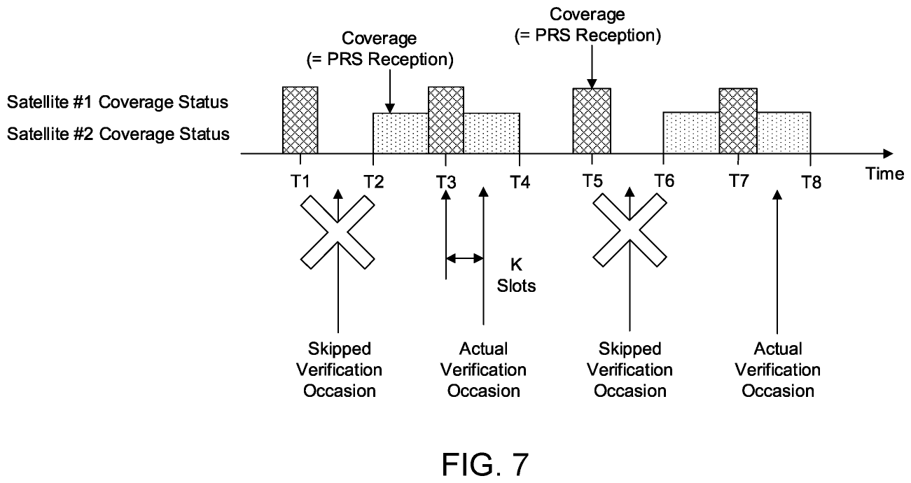

FIG. 7 is a diagram illustrating the configuration of a WTRU operating in accordance with periodic verification occasions. In the example shown in FIG. 7, the WTRU may be configured to communicate with satellite #1 and satellite #2, each satellite configured to move along different orbital paths over time. The WTRU may be configured with periodic verification occasions between T1 and T2 and between T5 and T6. Meanwhile, the coverage of satellite #1 may be such that PRS may be received at T1, T3, T5, and T7, while the coverage of satellite #2 may be such that PRS may be received between T2 and T4 and between T6 and T8. The WTRU may determine, e.g., based on ephemeris information for satellites #1 and #2, that the two occasions between T1 and T2, and between T5 and T6, are invalid since the WTRU cannot make measurements on PRS transmitted from either satellite due to coverage gaps. The WTRU may be unable to send verification information (e.g., measurements, and/or WTRU location estimates derived through GNSS-based methods) or make measurements on PRSs at the occasion. The WTRU may determine to skip verification occasions that are not valid.

The WTRU may determine the actual verification occasion based on one or more aspects. One aspect may be satellite ephemeris information. In the scenario illustrated in FIG. 7, for example, the WTRU may determine the timing of actual verification occasions when the WTRU is able to make measurements on received PRS and/or transmit SRS to the configured TRP(s) (e.g., satellite #1 and/or satellite #2). For instance, as shown in FIG. 7, the WTRU may determine that an actual verification occasion lies between T3 and T4, K slots following T3, at which time the WTRU is simultaneously within the coverage areas of satellite #1 and satellite #2. Another actual verification occasion may be determined between T7 and T8 at which time the WTRU is within a coverage area of satellite #2.

Another aspect to the WTRU's determination of actual verification occasions may be configured/dynamic grants for SRS transmission. For example, the WTRU may determine the actual verification occasion when the WTRU is configured with grants (e.g., configured or dynamic) to transmit SRS to the configured TRP(s) (e.g., satellites), if applicable, before the configured duration/time from the actual verification occasion.

In some examples, a WTRU may report to the network one or more parameters related to actual verification occasions. The parameters may include a periodicity of actual verification occasions; a start/end time of the actual verification occasions/duration of actual verification occasions; and/or a pattern of actual verification occasions. For example, there may be duration during which the WTRU cannot see the configured satellites. In some examples, the actual verification may not occur periodically. The WTRU may indicate the pattern of actual verification occasions via a sequence of bits, where the number of bits in the sequence corresponds to the number of occasions in a period.

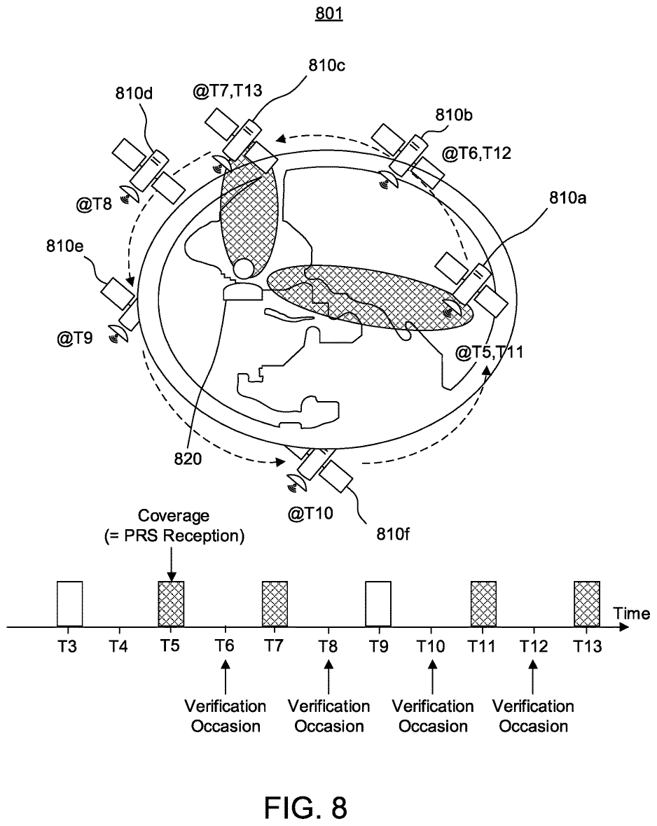

FIG. 8 is a diagram illustrating periods of visibility of satellites and the timing of verification occasions based on such periods. As shown in the example of the inset illustration 801 of FIG. 8, a satellite 810 may be configured to move along an orbital path over time, reaching positions 810a, 810b, 810c, 810d, 810e, and 810f at respective times T5/T11, T6/T12, T7/T13, T8, T9, and T10. A WTRU 820 may be configured to measure PRS from the satellite 810 and may be configured with verification occasions at T6, T8, T10 and T12. However, the satellite 810 may not be visible to the WTRU at T3 and, more significantly in this example, may not be visible (e.g., has NLOS with the WTRU) at T9, and therefore the WTRU 820 may determine to skip the verification occasion at T10. In the example illustrated in FIG. 8, the WTRU's configured verification occasions are periodic, and the occasions configured for a single period include occasions at T6, T8, T10 and T12, which cycle due to the ephemeris of the satellite 810. Thus, the WTRU 820 may send a pattern denoted by a bit sequence [1 1 0 1] to the network in the example shown, where “1” and “0” indicates verification occasion at which the WTRU can perform verification (e.g., make measurements on PRS) or the WTRU cannot perform verification, respectively. Since the satellite 810 may move according to a predictable ephemeris, the network may use the pattern to determine the occasions skipped by the WTRU 820.

In some examples, the WTRU may determine to report how often configured verification occasions are skipped to the network. For example, the WTRU may report density of actual verification occasion in configured verification occasions. For example, in the example illustrated in FIG. 7, introduced and described substantially in paragraphs above, the WTRU may indicate a density of 50% to the network, indicating that 1 out of 2 verification occasions is skipped. The WTRU may report a time duration (e.g., in seconds, number of symbols/slots/frames) until the next actual verification occasion. The WTRU may receive an ACK/NACK from the network, where the ACK/NACK indicates approval/rejection of the periodicity of the actual verification occasion reported by the WTRU. If the WTRU receives a rejection message (e.g., a message indicating the network cannot accept the periodicity at which actual verification occurs), the WTRU may determine to perform initial access to establish connection with the network.

In some examples, the WTRU may be configured by the network with information indicating list of periodicities. Based on ephemeris information for one or more satellites and the WTRU's location determined from GNSS (or GPS), the WTRU may determine, from the list of periodicities, the periodicity (or periodicities) of actual verification occasions. The WTRU may report the determined periodicity to the network. If, for example, the WTRU determines that more than one periodicities are applicable, the WTRU may determine to report the shortest/longest periodicity according to a preconfigured rule (e.g., the WTRU may send a report based upon a rule that is hard-coded in the specification).

In some solutions, resources may be limited according to an amount of skipped occasions. In one such example, the WTRU may determine that the quality of service the WTRU receives from the network may be associated with how often the WTRU skips configured verification occasions. For example, the WTRU may be configured by the network with a rule associating a frequency of skipped occasions and an amount of resources that may be scheduled for the WTRU. For example, according to the rule, the WTRU may determine that if the WTRU skips 50% of its configured verification occasions, the WTRU may be configured or allocated with up to 5 MHz of bandwidth for uplink transmission (e.g., PUSCH transmissions). In some examples, the WTRU may determine from the rule that if the WTRU is to send measurement reports and/or locations determined from GNSS/GPS-based methods at all configured occasions (e.g., without skipping verification occasions), the WTRU may be configured by the network with up to 100 Mhz of bandwidth.

In some exemplary embodiments, a WTRU may perform NW initiated verification. In one or more steps of an example procedure, the WTRU may receive assistance information (e.g., ephemeris information for one or more satellites) from the network. In one or more steps of a procedure, the WTRU may receive configuration information for verification periodicity (e.g., indicating that a verification occasion occurs at configured periodicity) and measurement duration (e.g., K slots) from the network. In one or more steps of a procedure, if the WTRU cannot make measurements for RAT dependent positioning at least within the measurement duration before the configured verification occasion (e.g., if there are not enough satellites for multi-RTT methods), the WTRU may report measurements obtained via RAT dependent positioning methods and may report a location estimate based on GNSS based methods at the next verification occasion. In such cases, the report may include a timestamp at which measurements have been made. In one or more steps of a procedure, the WTRU may report RAT dependent measurements, an estimated location derived using GNSS based methods to the network at an actual verification occasion, and timestamps at which the measurements have been made.

In some examples, the WTRU may send an indication of indices associated with verification occasions at which the WTRU may report measurements and/or location estimates obtained via GNSS based methods. In one or more steps of a procedure, the WTRU may receive assistance information (e.g., ephemeris information for one or more satellites, and/or information for RAT dependent positioning methods) and verification occasions via one or more broadcast messages. In one or more steps of a procedure, the WTRU may determine its location via GNSS based measurements. In one or more steps of a procedure, based on a verification occasion and ephemeris information, the WTRU may report the occasions (e.g., by sending an indication of verification occasion indices) for which the WTRU may report location estimate/measurements via GNSS based and RAT dependent positioning methods.

In some exemplary procedures, the WTRU may indicate an offset with reference to a configured verification occasion, at which time the WTRU may report measurements and/or location estimates obtained via GNSS based methods. The WTRU may receive assistance information (e.g., ephemeris information for one or more satellites, and/or information for RAT dependent positioning methods) and verification occasions via one or more broadcast messages. The WTRU may determine its location based on GNSS based measurements. Based on the verification occasion and ephemeris information, the WTRU may propose preferred parameters for verification occasions (e.g., shifted by N minutes).

In some exemplary embodiments, a WTRU may perform network initiated verification using more than one periodicity. The WTRU may be given a list of periodicities for verification occasions from the network. Based on the WTRU's location and based on ephemeris information, the WTRU may choose a periodicity from the list at which the WTRU may send measurement reports. If there are more than one determined periodicities, the WTRU may choose the shortest periodicity. In one or more steps of a procedure, the WTRU may receive assistance information (e.g., ephemeris information for one or more satellites) from the network. The WTRU may receive a list of verification periodicities from the network. Based on the list of periodicities, ephemeris information, and the WTRU's location determined via GNSS based methods, the WTRU may determine a periodicity, from the list, at which the WTRU reports the required measurements to the network. If the WTRU determines more than one periodicity from the list, the WTRU reports the shortest periodicity among the determined periodicities to the network. The WTRU may report the determined periodicity to the network. In some methods, at a preconfigured time (e.g., a start time of the verification) from the occasion WTRU reports the determined periodicity, and the WTRU may report the required measurements (e.g., RAT dependent measurements, a location estimated via GNSS based methods, and/or one or more time stamps) to the network at the verification occasion.

In some exemplary embodiments, a WTRU may be penalized for skipping verification occasions. For example, the network may request that the WTRU perform to perform location verification at a certain periodicity. If the WTRU cannot comply with the request (e.g., due to NLOS with a requisite number of satellites), the WTRU may experience degraded quality of service due to a compromised verification periodicity. If the WTRU cannot successfully complete location verification (e.g., at the requested periodicity), the WTRU may perform initial access.

In one or more steps of a procedure, the WTRU may receive, from the network, assistance information (e.g., ephemeris information for one or more satellites), information indicating an association between a frequency of skipped verification occasions, and a maximum bandwidth for the uplink channel (e.g., PUSCH) that the WTRU may request. The WTRU may receive configuration information for verification periodicity (e.g., indicating that verification occasions occur at a configured periodicity). Based on the ephemeris information and the WTRU's location determined via GNSS based methods, the WTRU may determine actual verification occasions. Based on the proportion of skipped verification occasions (e.g., (a number of configured verification—a number of actual occasions) divided by a configured number of verification occasions) and the received association configuration, the WTRU may determine the maximum bandwidth the WTRU can request for uplink transmission. The WTRU may transmit an indication of the determined maximum bandwidth it can request, e.g., using a MAC-CE, UCI, or any other logically equivalent messaging. If the WTRU cannot determine the verification occasion, the WTRU determines to perform an initial access procedure (e.g., the WTRU performs fallback behavior).

In some solutions a WTRU may send GPS information and receive actual verification occasions. For example, the WTRU may determine to send a location estimate obtained via GNSS/GPS based methods to the network according to an indication or configuration provided by the network. The WTRU may receive information indicating a periodicity of actual verification occasions and/or SRS configurations from the network based on the reported WTRU location. For example, the WTRU may receive SRS configurations, where the parameters (e.g., a start/end time of SRS transmission, periodicity, repetition factors) may be aligned with the configured actual verification occasions.

The WTRU may not report GNSS/GPS location information at actual verification occasions unless one or more conditions are satisfied. One condition may be that the WTRU moves more than a preconfigured threshold (e.g., expressed in meters). Another condition may be that the validation period for the location information derived based on GNSS/GPS is expired. Another condition may be that the WTRU receives an indication from the network to report the WTRU location information based on GNSS/GPS.

In some exemplary embodiments, a WTRU may perform network initiated verification with an initial GNSS based location estimate. In one or more steps of a procedure, the WTRU may receive assistance information (e.g., ephemeris information for one or more satellites) from the network. The WTRU may determine the preparation duration based on the WTRU's configuration or capabilities. The WTRU may determine or select satellites for which to perform measurements based on transmitted PRS. The WTRU may report to the network WTRU location information that is derived via GNSS based methods. The WTRU may receive a first periodicity of actual verification occasions from the network. At an actual verification occasion, the WTRU may report measurement results (e.g., RSRP, RSTD) made based on PRS transmitted by the selected satellites, and the WTRU may report the WTRU location information derived via GNSS based methods if the WTRU moves a distance that exceeds a configured or preconfigured threshold. If the WTRU receives a second periodicity that is based on the reported WTRU location estimate and associated with actual verification occasions, the WTRU may replace the first periodicity with the second periodicity. The WTRU may determine the next actual occasion based on the second periodicity and preparation duration.

In some solutions, a WTRU may determine an alignment of verification occasions with a scheduled location time. For example, the WTRU location verification occasions may be associated with a RACH configuration. In some examples, a preamble selected by the WTRU may be associated with a specific occasion in which to perform verification. A mapping between preamble selection and verification occasion(s) may be provided, for example, by the network, or indicated within system information. For example, a subset of preambles A-B may be associated with verification occasion X, and a subset of preambles B-C may be associated with verification occasion Y.

In some examples, a RACH occasion selected by the WTRU may indicate which verification occasion should used. The relationship between a RACH configuration and verification occasion may be defined by, for example, a specific offset from the RACH occasion, within a specific duration from the RACH occasion, and/or based on the closest verification occasion to the RACH occasion. In some examples, a WTRU may trigger WTRU location verification (e.g., perform positioning measurements for RAT dependent positioning method(s), determine the WTRU location from GNSS, and/or transmit a measurement report to the network) when any of the verification occasions overlap with at least one configured set of Scheduled Location Time (SLT) ( ) occasions. In cases when the duration of a verification occasion is greater than an SLT occasion during an overlapping window between the occasions, the WTRU may restrict the WTRU location verification to the duration of the verification occasion, possibly to ensure service continuity, for example.

In some examples, the WTRU may send WTRU location verification information (e.g., measurements for RAT dependent positioning method(s), WTRU location determined GNSS) at the SLT if one or more conditions are satisfied. One condition may be that the SLT occurs in between WTRU location verification occasions. One condition may be that the SLT occurs before the first verification occasion during the verification window/after the WTRU receives a request to initiate the WTRU location verification from the network. One condition may be that the SLT occurs after the last verification occasion during the verification window/after the WTRU receives a request to terminate the WTRU location verification from the network. One condition may be that the WTRU receives an indication/configuration from the network to perform WTRU location verification occasion at the SLT.

In some examples, the WTRU may receive, from the network (e.g., LMF, base station), configuration information related to SLT occasions (e.g., the time at which the WTRU needs to report its location/measurements made on PRS, periodicity of SLT occasion, content of the WTRU report). In some examples, the WTRU may receive a request for SLT occasions from the network to report location information (e.g., measurements, and/or the WTRU's location).

In some examples, the WTRU may determine to use a new verification occasion based on an event occurring at a preconfigured time before/after the event, where the preconfigured time is expressed in terms of a time unit (e.g., slots, symbols, frames, seconds, hours). For example, the WTRU may determine that an event has occurred based upon at least one of the following triggers. One trigger may be the occurrence of an SLT where the WTRU may trigger WTRU location verification at a preconfigured time window before the next verification/SLT occasion. Another trigger may be a request from the network to perform location verification, where the WTRU may trigger the WTRU location verification after the WTRU receives the request from the network. Another trigger may be the reception of an RRC_Release message (e.g., a request from the network to the WTRU to transition to RRC_INACTIVE state), where the WTRU may trigger WTRU location verification after the WTRU receives the request from the network. Another trigger may be a scheduled call from the WTRU, where the WTRU may trigger WTRU location verification at a preconfigured time before the next scheduled call. For example, the WTRU may be a sensor that periodically reports measurement data (e.g., temperature, and/or air pressure) to the network.

In some examples, the WTRU may trigger an early location verification when determining events/conditions associated with discontinuous coverage during any of the next verification and/or SLT occasions. In such cases, the WTRU may initiate WTRU location verification at a preconfigured time (e.g., N slots) before the next verification/SLT occasion when the discontinuous coverage event is expected to overlap with the next verification/SLT occasion. The WTRU may skip WTRU location verification in the associated occasions that overlap with the discontinuous coverage events. The WTRU may send an indication to the network, possibly in any of the earlier verification/SLT occasions, when the WTRU determines there is an overlap between discontinuous coverage events and subsequent verification/SLT occasions, for example.

In some examples, the WTRU may determine a validity of a new verification occasion based on at least one of the following conditions. One condition may be that the new verification occasion is valid if the WTRU may send the report to the network, where the report contains measurements that the WTRU made on PRS transmitted from configured TRPs (e.g., satellites). One condition may be that the new verification occasion is valid if the WTRU may make measurements on PRS from the minimum number of TRPs (e.g., satellites) for the configured positioning method. Another condition may be that the new verification occasion may be valid if the new verification occasion occurs at a preconfigured time (e.g., K slots) after a verification occasion such that the WTRU does not need to perform location verification during a short period of time. In some examples, the WTRU may determine to perform WTRU location verification at a preconfigured time before the next verification/SLT occasion if it is feasible to perform verification.

In some examples, if the WTRU determines that the new verification occasion is not valid, the WTRU may perform one or more actions. One action may be the WTRU may indicate that the location information/measurements returned at SLT is based on the determined verification occasion (e.g., by including timestamp of the measurement, the determine verification occasion may be one of the determined periodic occasions). Another action may be that the WTRU may not return location information/measurements at the SLT.

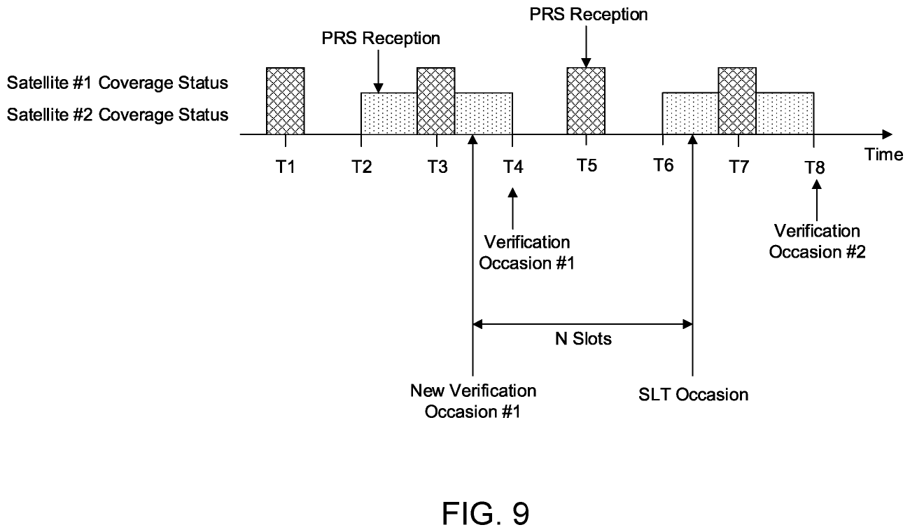

FIG. 9 is a diagram illustrating the determination of a new verification occasion.

In the example shown in FIG. 9, a WTRU may be configured to receive and measure PRS from two satellites, satellite #1 and satellite #2. The WTRU may determine a periodicity of verification occasions based at least on the coverage of each satellite. As shown in FIG. 9, satellite #1 may provide coverage in an area of the WTRU at times T1, T3, T5, and T7. Satellite #2 may provide coverage in an area of the WTRU between T2 and T4 and between T6 and T8. The WTRU may be configured with a verifications occasions at T4 and at T8 and with an SLT occasion between T6 and T7. Based on the SLT occasion, the WTRU may determine to create a new verification occasion at a preconfigured time (e.g., N slots) before the SLT occasion. It should be noted that in the example shown in FIG. 9 the SLT occasion occurs during a period in which the WTRU has coverage under satellite #2 only. However, in other examples not shown in FIG. 9, the timing of SLT occasion may not be limited to scenarios with partial coverage but may be determined in scenarios where the WTRU has no satellite coverage (e.g., when the WTRU receives PRS from neither satellite #1 and satellite #2). In other examples not shown in FIG. 9, the timing of SLT occasion may not be limited to scenarios with partial coverage but may be determined in scenarios where the WTRU has full satellite coverage (e.g., when the WTRU receives PRS from both satellite #1 and satellite #2).

Since the WTRU may make measurements PRS from both Sat #1 and Sat #2 at the new verification occasion, a new verification occasion as shown between T3 and T4 in FIG. 9 may be determined to be valid. Thus, the WTRU may determine to perform location verification (e.g., perform measurements on PRS from satellite #1 and from satellite #2) at the new verification occasion.

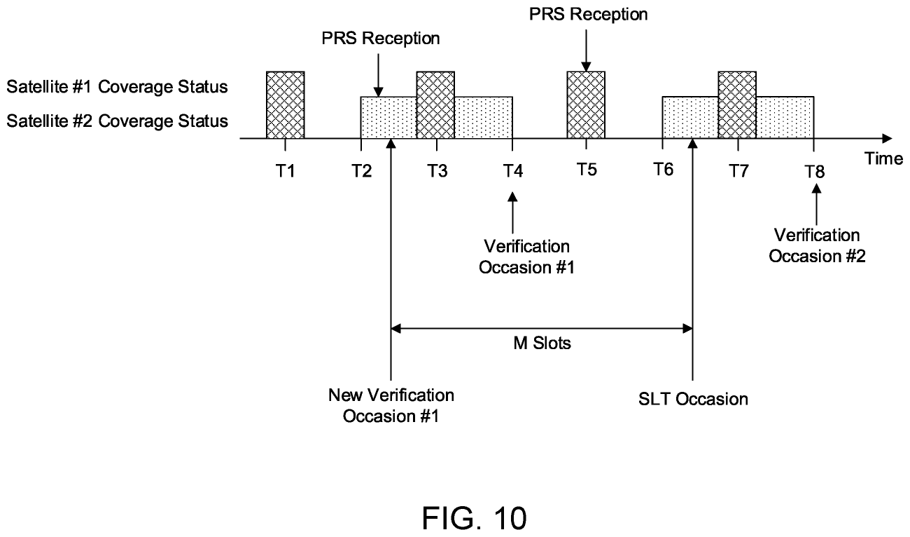

FIG. 10 is a diagram illustrating a rejection of a new verification occasion. In the example illustrated in FIG. 10, a WTRU may again be configured to receive and measure PRS from two satellites, satellite #1 and satellite #2. Satellite #1 may provide coverage in an area of the WTRU at times T1, T3, T5, and T7. Satellite #2 may provide coverage in an area of the WTRU at T2-T4 and T6-T8. The WTRU may be configured with verification occasions at T4 and at T8 and with an SLT occasion between T6 and T7. Between T2 and T3, the WTRU may have coverage only from satellite #2 The WTRU may determine to create a new verification occasion at the preconfigured time (e.g., M slots) before the SLT occasion. However, in the example shown in FIG. 10, since the WTRU may only take measurements on PRS received from satellite #2 in the new verification occasion, the WTRU may determine that the new verification occasion is invalid. Thus, the WTRU may determine to perform verification at verification occasion #1 (e.g., at time T4 as shown in FIG. 10).

Methods for WTRU-initiated periodic location verification are described herein. In some examples, the WTRU may determine verification occasions based on the configured ephemeris of one or more satellites. For example, the WTRU may determine a start time and periodicity of verification occasions based on the ephemeris information (e.g., how many satellites are visible to the WTRU, and/or periodicity of visibility) and RAT dependent positioning method (e.g., single/multi-satellite based positioning).

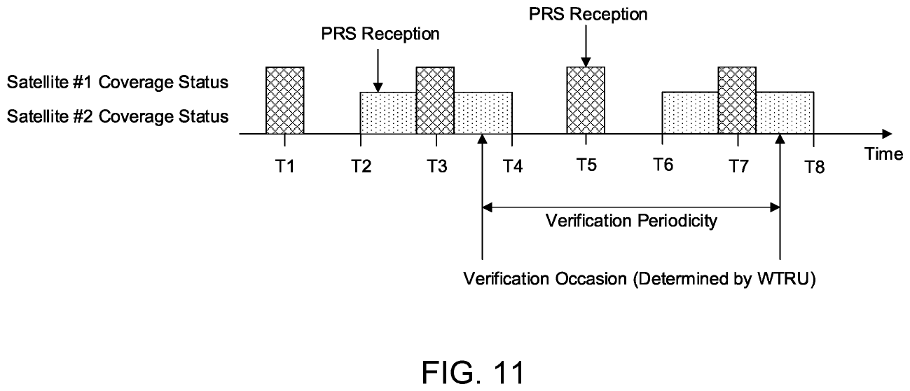

FIG. 11 is a diagram illustrating an example of a location verification determination made by a WTRU. In the example shown in FIG. 11, the WTRU may be configured to receive and measure PRS from two satellites, satellite #1 and satellite #2. Satellite #1 may provide coverage in an area of the WTRU at times T1, T3, T5, and T7. Satellite #2 may provide coverage in an area of the WTRU from T2-T4 and from T6-T8. Based on the ephemeris information and the coverage status of satellites #1 and #2, the WTRU may determine that verification occasions are present between T3 and T4 and between T7 and T8, at which times the WTRU may lie within coverage areas of both satellites #1 and #2. The WTRU may evaluate the duration of time between these two verification occasions, and may further determine a verification occasion periodicity based on the duration of time.

In some examples, if the WTRU determines more than one periodicity that may be used for verification occasions, the WTRU may determine the periodicity that it should use in a procedure having one or more steps. In one or more steps of the procedure, the WTRU may determine a list of periodicities for verification occasion, sorted by the duration of periodicity. In one or more steps of the procedure, the WTRU may report to the network the longest periodicity as the verification periodicity and corresponding start time. In one or more steps of the procedure if the WTRU does not receive the acknowledgement message from the network, the WTRU may select the second longest periodicity, and corresponding start time, from the candidate list. The WTRU may report to the network the periodicity as the verification periodicity.

In some examples, based on the WTRU's location and ephemeris information of one or more satellites, the WTRU may determine more than one periodicity may be used for verification occasions.

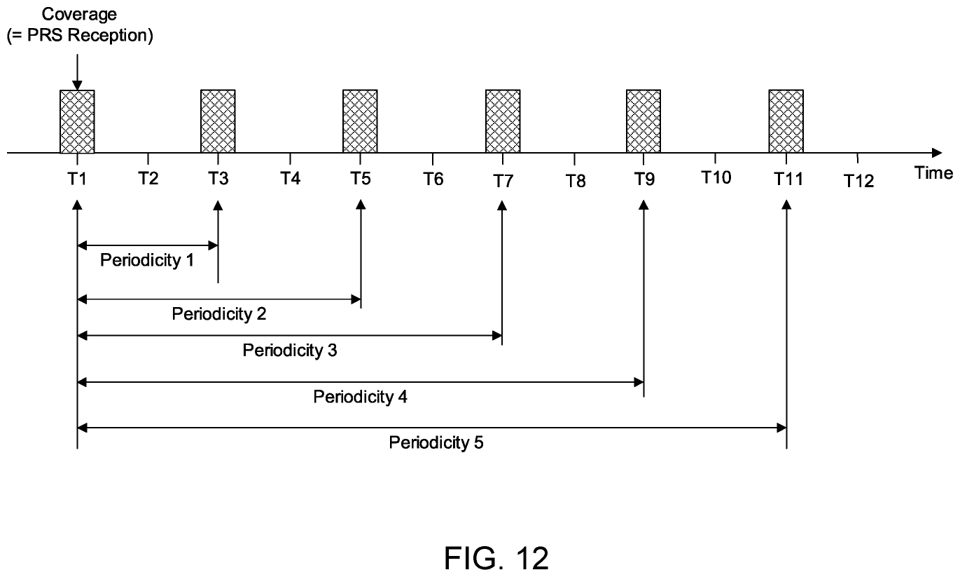

FIG. 12 is a diagram illustrating an example in which the WTRU determines and evaluates more than one possible periodicity for verification occasions. In the example shown in FIG. 12, the WTRU may be configured to receive and measure PRS from at least one satellites. The satellite may provide coverage in an area of the WTRU at times T1, T3, T5, T7, T9, and T11. The WTRU may evaluate the duration of time between an initial time (T1) at which the WTRU is within the satellite's coverage and each subsequent time (T3, T5, T7, T9, and T11) at which the WTRU again within the satellite's coverage. As a result, the WTRU may determine at least five different possible periodicities for verification occasions in the example shown in FIG. 12. The shortest periodicity, is shown in FIG. 12 as periodicity 1, and periodicities 2 to 5 are multiples of periodicity 1. Each periodicity may calculated by the equation M*T, where M is an integer and T is the time interval given by periodicity 1 in the example of FIG. 12.

The WTRU may be configured with rules (e.g., thresholds) on how to determine the periodicity for WTRU location verification. In some examples, the WTRU may determine a periodicity of verification occasions based on one or more parameters.

One parameter may be a relative location with respect to the center of a cell (e.g., a NTN cell). In some examples, the WTRU may be required to perform WTRU location verification more frequently if the WTRU is located closer to the edge of the cell. For example, the WTRU may be preconfigured with ranges of relative distances from the center. Based on the determined WTRU location (e.g., the location determined via GNSS based methods), the WTRU may determine the range within which the WTRU is located. The WTRU may also be configured with rules associating each range with a required (e.g., minimum/maximum) periodicity. If the WTRU determines more than one periodicity, the WTRU may select the periodicity based on a rule and/or the WTRU's location. For example, if the WTRU determines more than one periodicities, the WTRU may determine to select a shorter periodicity (e.g., providing more frequent verification occasion) if the WTRU is located further away from the center of the cell. The WTRU may select a longer periodicity (e.g., less frequent verification occasion) if the WTRU is located closer to the center of the cell.

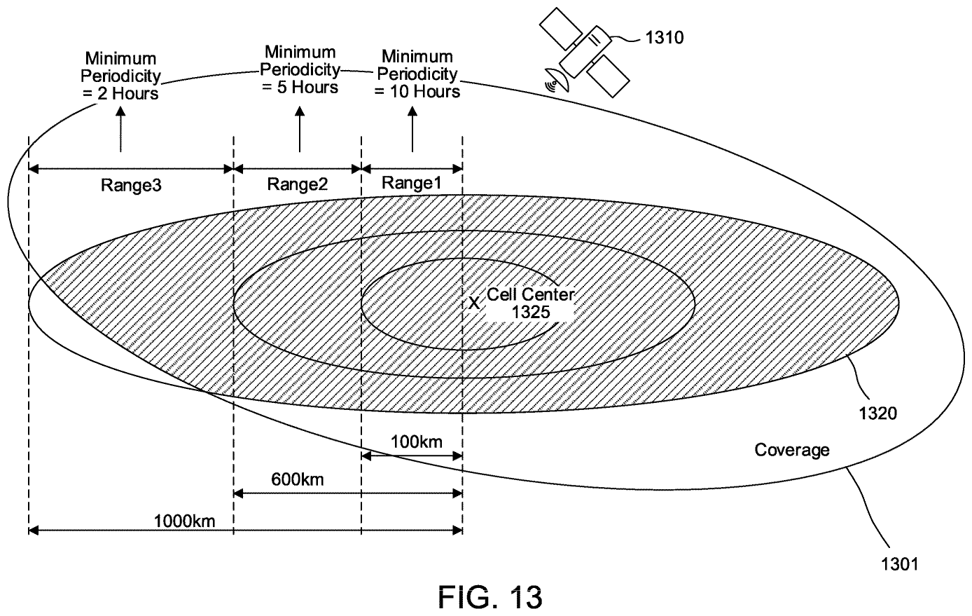

FIG. 13 is a diagram illustrating an example of a relationship between a required minimum periodicity for verification and a range with respect to the center of a NTN cell. In the example shown in FIG. 13, a satellite 1310 may provide cellular coverage within a coverage area 1301. The coverage area 1301 may encompass a cell 1320 having a cell center 1325. As illustrated in FIG. 13, coverage ranges within the cell may be designated at exemplary distances of 100 km, 600 km, and 1000 km from the cell center 1325. However, in other examples not shown in FIG. 13, the reference point may not be limited to the cell center 1325. The reference point can be determined by the network and indicated to the WTRU. Each range, with respect to the cell center, may be associated with a required minimum periodicity. If a WTRU operating within the cell 1320 determines that it is located in range 3 (between 600 km and 1000 km away from the cell center), the WTRU may be required to perform WTRU location verification at least every 2 hours. For example, based on the configured association rule between range of the distance away from the cell center and minimum periodicity illustrated in FIG. 13, if the WTRU determines that it is located 500 km away from the cell center 1325, the WTRU may determine that the minimum periodicity for WTRU location verification is 5 hours. In another example, based on the configured association rule between range of the distance away from the cell center and minimum periodicity illustrated in FIG. 13, if the WTRU determines that it is located 900 km away from the cell center 1325, the WTRU may determine that the minimum periodicity for WTRU location verification is 2 hours. Thus, the WTRU may determine, based on its location estimate, and based upon configured rules associating the range and required minimum periodicity of WTRU verification, the periodicity for WTRU location verification should be at least 2 hours.

Another parameter for determining a periodicity for location verification may be a priority level associated with the longest/shortest periodicity. For example, the WTRU may be configured with a priority level or a rule that is hard coded in the WTRU's specification and indicating whether the WTRU should report the longest/shortest periodicity if the WTRU determines more than one periodicity. If the WTRU determines that the periodicity reported to the network is not accepted by the network, the WTRU may determine to report the periodicity that is longer/shorter than the periodicity reported.

Another parameter for determining a periodicity for location verification may be a service requirement. For example, the WTRU may be configured with a service requirement (specifying, e.g., how long the service can tolerate absence of WTRU location verification, a minimum periodicity, and/or maximum periodicity). Based on the service requirement, the WTRU may determine a periodicity that satisfies the requirement.

Another parameter for determining a periodicity for location verification may be whether the WTRU is in the RRC_CONNECTED or the RRC_INACTIVE/IDLE state. If the WTRU is in INACTIVE mode, the WTRU may need to conserve battery power and the WTRU may not be able to perform WTRU verification as often as when the WTRU operates in RRC_CONNECTED state. The WTRU's state may determine the periodicities that the WTRU is capable of maintaining. The WTRU may determine periodicities based on the WTRU's capability or based on configuration information from the network (for example, in some configurations, when the WTRU is in RRC_CONNECTED or RRC_INACTIVE, the minimum periodicity that the WTRU may report is 2 hours or 10 hours, respectively).

Another parameter for determining a periodicity for location verification may be a periodicity of SRS transmissions. In some examples, the WTRU may be configured with grants (e.g., configured/dynamic grants) for SRS transmissions. The WTRU may determine a periodicity of verification occasions based on SRS transmissions. For example, the WTRU may determine a verification occasion that is within the preconfigured time (e.g., N slots) from an SRS transmission. In some examples, the WTRU may be configured with more than one set of SRS configurations. The WTRU may determine to select the periodicity of SRS transmissions based on ephemeris information (e.g., based on a periodicity that is aligned with the ephemeris of a satellite).

In some examples, the WTRU may be configured with more than one set of SRS configurations. The WTRU may determine the periodicity of SRS transmissions based on the determined periodicity of actual verification occasions.

The WTRU may report a determined verification parameter to the network. The WTRU may receive an approval/acknowledgement message from the network for the determined and reported verification parameter(s). In one example, the WTRU may receive one or more messages (e.g., via RRC, LPP, MAC-CE, DCI, or other logically equivalent messages) from the network after the WTRU sends the determined verification parameters to the network.

One message may be an acknowledgment message, approving the verification parameters determined by the WTRU. Another message may be a message rejecting the verification parameters determined by the WTRU. Another message may be a message denying the requested service from the WTRU (e.g., call, data transmission/reception request, emergency call). Another message may be a message including verification parameters (e.g., a periodicity). In some examples, the WTRU may receive the verification parameters from the network, which may be determined by the network based on the verification parameters determined and/or reported by the WTRU.

Another message may include an information request from the network. In some examples, the WTRU may receive a request from the network requesting additional information (e.g., an RSRP of PRS from specific satellite(s), and/or a WTRU ID). Another message may include a QoS indication. In some examples, the WTRU may receive a QoS indication (e.g., a change in positioning requirement, reporting requirements, data service rate, change in maximum/minimum configurable PRS parameter such as bandwidth, change in time for scheduled call/SLT) based on the verification parameters determined and/or reported by the WTRU.

In some examples, the determined periodicity of actual verifications may be based on the positioning method the WTRU is configured with. For example, based on the positioning method, the number of TRPs (e.g., satellites) may be different. Based on the ephemeris information and the number of satellites required for the positioning method, the WTRU may determine the periodicity of actual verification occasions at which the WTRU can report measurements to the network.

In an exemplary embodiment, a WTRU may perform WTRU-initiated verification. The WTRU may determine the periodicity for verification. The WTRU may send an indication of the determined periodicity to the network, and may determine whether it is acceptable by the network. If not, the WTRU may keep determining and sending periodicity information in the order of duration (e.g., longest to shortest). If none is acceptable, the WTRU may determine to perform initial access.

In one or more steps of a procedure, the WTRU may receive assistance information (e.g., ephemeris information for one or more satellites, and/or information for RAT dependent positioning methods) from the network. The WTRU may determine its location based on GNSS measurements. Based on ephemeris of one or more satellites, the configured RAT dependent positioning methods (e.g., DL-TDOA) and determined location, the WTRU may determine verification parameters (e.g., a periodicity). If the WTRU determines more than one periodicity, the WTRU may determine or select the longest periodicity. The WTRU may report the determined verification parameters (e.g., periodicity) to the network. If the WTRU receives an ACK from the network, the WTRU may perform a RAT dependent positioning before the verification occasion (e.g., at preconfigured time from when the WTRU received the ACK). The WTRU may send a GNSS based location estimate and measurements performed via RAT dependent positioning methods to the network at the verification occasion. If the WTRU does not receive the ACK from the network (e.g., within a preconfigured time from the time the WTRU sent the determined verification parameters), and if the WTRU determined more than one periodicity, the WTRU may select the next longest periodicity (e.g., second longest) and report it to the network. If the WTRU does not receive the ACK from the network, the WTRU may repeat the procedure until the WTRU does not have any candidate periodicities remaining. Otherwise, the WTRU may determine to perform initial access procedure (i.e., the WTRU may carry out fallback behavior).

In some embodiments, a WTRU may perform WTRU-initiated verification using a required periodicity obtained from the network. In one or more steps of a procedure, the WTRU may receive assistance information (e.g., ephemeris information for one or more satellites, and/or information for RAT dependent positioning methods) from the network. The WTRU may determine its location based on GNSS measurements. Based on ephemeris information for one or more satellites, the configured RAT dependent positioning methods (e.g., DL-TDOA) and the determined location, the WTRU may determine a periodicity. If the WTRU determines more than one suitable verification parameter values (e.g., periodicity), the WTRU may determine the longest periodicity. The WTRU may report the determined periodicity to the network. If the WTRU receives an ACK from the network, the WTRU may perform RAT dependent positioning before the verification occasion (e.g., at preconfigured time from the time the WTRU received ACK). The WTRU may send a GNSS based location estimate and measurements from RAT dependent positioning method to the network at the verification occasion.

If the WTRU does not receive the ACK from the network (e.g., within a preconfigured time from the time the WTRU sent the determined verification parameters), and if the WTRU determined more than one periodicity, the WTRU may select the next longest periodicity (e.g., second longest) and report it to the network. The WTRU may repeat the procedure until the WTRU does not have any candidate periodicities. Otherwise, the WTRU may determine to perform an initial access procedure (i.e., the WTRU may carry out fallback behavior).

Requests for SRS configuration are described herein. In some examples, the WTRU may determine to send a request to the network for SRS configurations that are aligned with actual verification occasions. For example, the WTRU may determine that the periodicity of one or more actual verification occasions is 6 hours. The WTRU may determine to send a request to the network for a SRS configuration specifies a periodicity for SRS transmissions of 6 hours.

Methods for light verification are described herein. In some examples, the WTRU may determine a periodicity of actual verification occasions and report the periodicity, location information determined from GNSS and/or satellite IDs/TRP IDs from which the WTRU may make measurements. Depending on the configured positioning method, the WTRU may also indicate in the report the SRS configuration(s) used for SRS transmissions. Based on the reported information, the network may be able to validate the WTRU location since IDs of visible satellites and periodicity of actual verification occasions may implicitly indicate the WTRU location. In one or more steps of a procedure, the WTRU may receive assistance information (e.g., ephemeris information for one or more satellites, and/or information for RAT dependent positioning methods) and information indicating a minimum number of satellites, N, from the network. The WTRU may determine its location based on GNSS measurements. Based on ephemeris information for one or more satellites, the WTRU may determine actual verification occasions, corresponding satellite IDs and a periodicity of the verification occasion, the number of satellites may greater than or equal to N. The WTRU may report a periodicity of the actual verification occasions, satellite IDs and location information determined via GNSS based methods to the network.

In some solutions, the WTRU may alternate positioning methods or to use more than one positioning method. For example, the WTRU may determine to use multiple positioning method. The WTRU may determine there are more than one set of actual verification occasions. For a set of actual verification occasions, the WTRU may determine to perform single-satellite based positioning methods (e.g., RTT-based positioning method). For another set of verification occasions, the WTRU may determine to perform multi-satellite based positioning methods (e.g., DL-TDOA). The WTRU may determine to employ more than one positioning method at actual verification occasions based on one or more conditions. One condition may be based on ephemeris information establishing that the WTRU may perform a single-satellite based positioning method (e.g., RTT-based positioning method) at a set of actual occasions and that the WTRU may perform a multi-satellite based positioning method (e.g., DL-TDOA). If the WTRU determines set(s) of actual verification occasions are present, the WTRU may determine to report the parameters for each set (e.g., periodicity of actual verification occasion, associated positioning method) to the network. Another condition may be based on one or more configurations indicated by the network. For example, the WTRU may be configured with more than one set of verification occasions and the WTRU may determine to use the positioning method associated with each set of occasions.

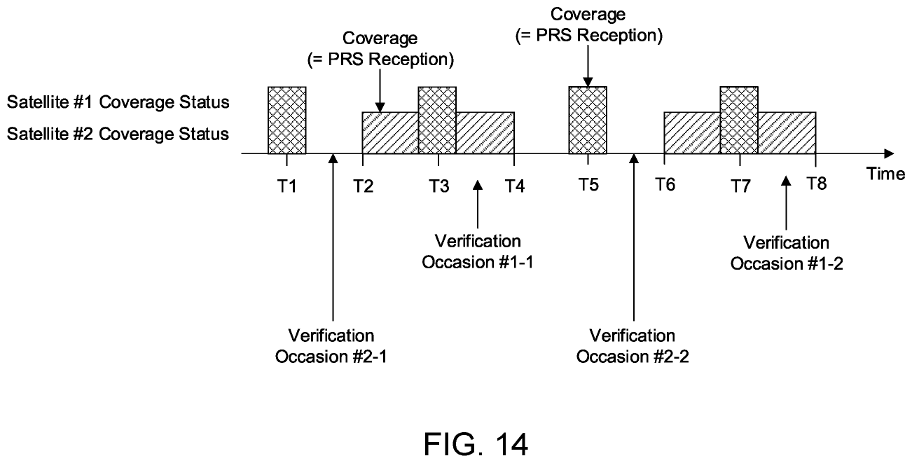

FIG. 14 is a diagram illustrating examples of sets of verification occasions. As shown in FIG. 14, a WTRU may be configured to receive and measure PRS from two satellites, satellite #1 and satellite #2. Satellite #1 may provide coverage in an area of the WTRU at times T1, T3, T5, and T7. Satellite #2 may provide coverage in an area of the WTRU at from T2-T4 and from T6-T8. The WTRU may determine that there are two sets of verification occasions (e.g., based on ephemeris and/or configuration information from then network): a first set including verification occasion #1-1 located between T3 and T4 and verification occasion #1-2 located between T7 and T8; and a second set including verification occasion #2-1 located between T1 and T2 and verification occasion #2-2 located between T5 and T6.

In the example shown in FIG. 14, the WTRU may also be configured with more than one positioning method. Alternatively, or additionally, based on the ephemeris, the WTRU may determine to use more than one positioning method. The WTRU determines two sets of actual verification occasions based on the ephemeris. For verification occasions #1-1 and #1-2, the WTRU may determine that the WTRU may take measurements from both satellites #1 and #2 given the WTRU is within the coverage areas of both satellites at these times. Thus, the WTRU may determine to use a positioning method that requires measurements from more than one TRPs/satellites (e.g., DL-AoD). For verification occasions #2-1 and #2-2, the WTRU determines that the WTRU may take measurements on PRS from only one TRP/satellite at a time, because the WTRU is within the coverage area of satellite #1 only during verification occasions #2-1 and #2-2. Therefore, the WTRU may determine to use the positioning method that requires measurements from one TRP/satellite over a configured interval (e.g., the WTRU may use RTT-based positioning methods).

In some examples, the WTRU may report to the network which positioning method(s) the WTRU is capable of performing based on the ephemeris of satellites. Based on the positioning methods that the WTRU is capable of using, the WTRU may receive configuration information related to actual verification occasions (e.g., periodicity information). If applicable, the WTRU may receive information for more than one set of verification occasions, where each set may be associated with a positioning method.

Mobility event-based verification may be further described as follows. If a WTRU determines that it moved further than a configured threshold, the WTRU may determine to trigger WTRU location verification. The location verification may take place within the time limit from the mobility event. Otherwise, the WTRU may need to perform initial access to establish connection with the network.

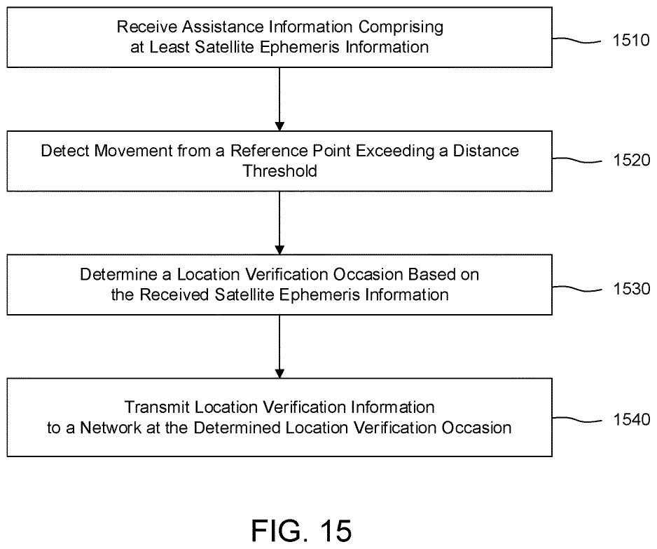

FIG. 15 is a flow diagram illustrating an example procedure for mobility triggered verification. As shown at 1510, a WTRU may receive assistance information (e.g., ephemeris information for one or more satellites, configuration information for RAT dependent positioning methods), first and second threshold (e.g., expressed in meters and hours, respectively) from the network (e.g., LMF, base station, or TRP). As shown at 1520, the WTRU may detect that it moved a distance from the reference point (e.g., the reported location at the previous reporting occasion, cell center) above a first threshold (detected mobility event). The WTRU may determine one or more verification occasions based on the received ephemeris information, as shown at 1530. The WTRU may transmit verification information to the network at the determined verification occasion, for example, if the determined verification occasion is within the second threshold from the time of the detected mobility event, as shown at 1540.

The verification information may include e.g. the location determined by the RAT dependent positioning method, location estimate obtained from GNSS and/or measurement reports (e.g., RSTD for DL-TDOA, RSRP) when the information becomes available. If the determined verification occasion is after preconfigured time from the time of the detected mobility event, the WTRU may perform initial access to establish connection with the network.

Network initiated verification with a penalty for skipped occasions may be further described as follows. The network may want to perform WTRU location verification at certain periodicity. If the WTRU cannot comply with the request (e.g., due to the lack of satellites the WTRU sees), the WTRU may determine that the quality of service associated with the compromised periodicity. If the WTRU cannot determine the verification occasion, the WTRU may perform initial access.

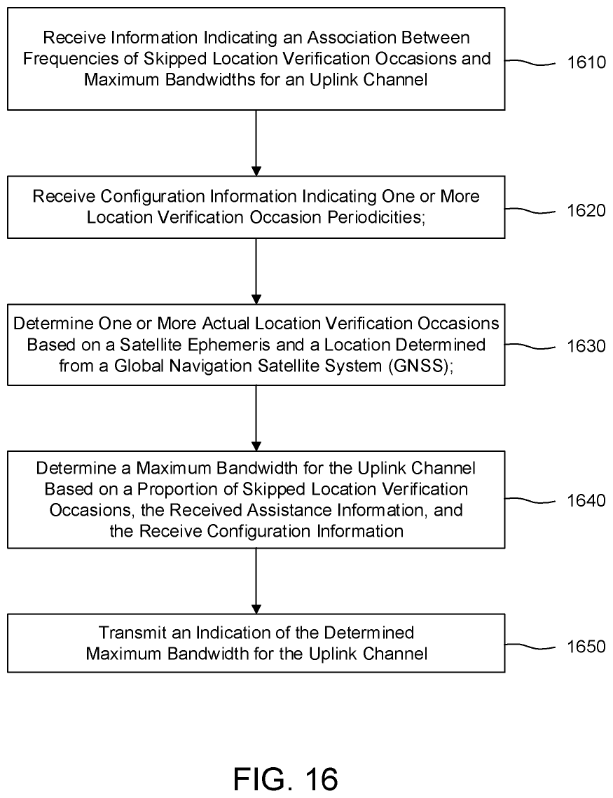

FIG. 16 is a flow diagram illustrating an example procedure for network initiated verification with a penalty for skipped occasions. As shown at 1610, The WTRU may receive assistance information from the network (e.g., ephemeris of satellites) and information indicating an association between frequencies of skipped verification occasions and maximum bandwidth for the uplink channel (e.g., PUSCH) the WTRU can request.

As shown at 1620, the WTRU may receive configuration information for the verification periodicity (e.g., providing verification occasions that occur at the configured periodicity). Based on the ephemeris information and the WTRU location determined using GNSS based methods, as shown at 630, the WTRU may determine actual verification occasions. Based on the proportion of skipped verification occasion (e.g., (a number of configured verification occasions—a number of actual occasions) over the configured number of verification occasions) and the received association configuration, the WTRU may determine the maximum bandwidth the WTRU can request for uplink transmission, as shown at 1640.

As shown at 1650, the WTRU may transmit an indication of the determined maximum bandwidth it can request. The transmitted indication may be sent, for example, using a MAC-CE, UCI, or another logically equivalent message. If the WTRU cannot determine the verification occasion, the WTRU may determine to perform initial access procedure (i.e., perform fallback behavior).

Methods for WTRU-initiated verification are further described herein. A WTRU may determine the periodicity for verification. The WTRU may send the periodicity to the network, and determine whether it is acceptable to the network. If not, the WTRU may keep sending the periodicity in the order of duration (e.g., longest to shortest). If none is acceptable, the WTRU may determine to perform initial access.

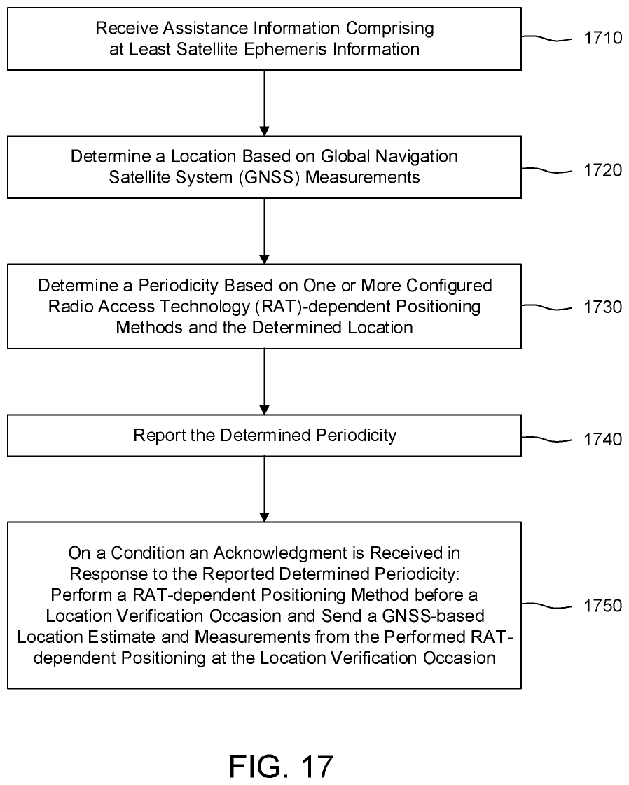

FIG. 17 is a flow diagram illustrating an example procedure for WTRU-initiated location verification. A WTRU may receive assistance information (e.g., ephemeris of satellites, RAT dependent positioning method) from the network. The WTRU may determine its location based on GNSS measurements. Based on ephemeris of satellites, configured RAT dependent positioning methods (e.g., DL-TDOA) and determined location, the WTRU may determine a periodicity. If the WTRU determines more than one suitable verification parameter values (e.g., periodicity), the WTRU may determine the longest periodicity. The WTRU may report the determined periodicity to the network.

If the WTRU receives an ACK from the network, the WTRU may perform RAT-dependent positioning before the verification occasion (e.g., at preconfigured time from the time the WTRU received ACK). The WTRU may send a GNSS-based location estimate and measurements from RAT dependent positioning method to the network at the verification occasion.

If the WTRU does not receive the ACK from the network (e.g., within a preconfigured time from the time the WTRU sent the determined verification parameters), and if the WTRU determined more than one periodicity, the WTRU selects the next longest periodicity (e.g., second longest) and report it to the network. The WTRU may repeat the procedure until the WTRU does not have any candidate periodicities. Otherwise, the WTRU may determine to perform an initial access procedure (fallback behavior).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for mobility-triggered location verification performed by a wireless transmit/receive unit (WTRU), the method comprising:
receiving, from a network, assistance information comprising one or more of: ephemeris information associated with at least one satellite, an indication of a distance threshold;
detecting a mobility event based on an amount of movement, by the WTRU, that exceeds the distance threshold; and
on a condition a location verification occasion is expected after the detected mobility event but before a time duration, starting from the detected mobility event, has elapsed:
transmitting location verification information to the network at the location verification occasion.

2. The method of claim 1, comprising, on a condition a location verification occasion is expected after the detected mobility event after the time duration, starting from the detected mobility event, has elapsed:
attempting an initial access procedure to establish a connection to the network.

3. The method of claim 1, wherein the location verification information comprises an estimated location of the WTRU determined using a global navigation satellite system (GNSS)-based method.

4. The method of claim 1, wherein the location verification information comprises an estimated location of the WTRU determined using a radio access technology (RAT)-dependent positioning method.

5. The method of claim 1, wherein the mobility event is determined based on an amount of movement, by the WTRU, from a location where the WTRU previously performed location verification.

6. The method of claim 1 comprising sending sounding reference signals to one or more of the at least one satellite to support radio access technology (RAT)-dependent positioning methods.

7. The method of claim 1, wherein the network is a terrestrial network comprising at least one base station.

8. The method of claim 1, wherein the assistance information is received after entry, by the WTRU, into a coverage area of a non-terrestrial network (NTN) associated with the at least one satellite.

9. The method of claim 1, wherein the assistance information is received in one of system information, a random access channel (RACH) message, a medium access control (MAC) control element (CE), or a radio resource control message (RRC).

10. A wireless transmit/receive unit (WTRU) configured to perform mobility-triggered location verification, the WTRU comprising:
a processor; and
a transceiver;
the processor and the transceiver configured to receive, from a network, assistance information comprising one or more of: ephemeris information associated with at least one satellite, an indication of a distance threshold;
the processor and the transceiver configured to detect a mobility event based on an amount of movement, by the WTRU, that exceeds the distance threshold; and
the processor and the transceiver configured to, on a condition a location verification occasion is expected after the detected mobility event but before a time duration, starting from the detected mobility event, has elapsed:
transmit location verification information to the network at the location verification occasion.

11. The WTRU of claim 10, the processor and the transceiver configured to, on a condition a location verification occasion is expected after the detected mobility event after the time duration, starting from the detected mobility event, has elapsed:
attempt an initial access procedure to establish a connection to the network.

12. The WTRU of claim 10, wherein the location verification information comprises an estimated location of the WTRU determined using a global navigation satellite system (GNSS)-based method.

13. The WTRU of claim 10, wherein the location verification information comprises an estimated location of the WTRU determined using a radio access technology (RAT)-dependent positioning method.

14. The WTRU of claim 10, wherein the mobility event is determined based on an amount of movement, by the WTRU, from a location where the WTRU previously performed location verification.

15. The WTRU of claim 10 comprising sending sounding reference signals to one or more of the at least one satellite to support radio access technology (RAT)-dependent positioning methods.

16. The WTRU of claim 10, wherein the network is a terrestrial network comprising at least one base station.

17. The WTRU of claim 10, wherein the assistance information is received after entry, by the WTRU, into a coverage area of a non-terrestrial network (NTN) associated with the at least one satellite.

18. The WTRU of claim 10, wherein the assistance information is received in one of system information, a random access channel (RACH) message, a medium access control (MAC) control element (CE), or a radio resource control message (RRC).
